(19) United States
(12) Patent Application Publication
(10) Pub. No.: US 2009/0322260 A1
(43) Pub. Date: Dec. 31, 2009

(54) ELECTROSTATIC MICROACTUATOR

(76) Inventor: Ki Bang Lee, Singapore (SG)

Correspondence Address: DARBY & DARBY P.C., P.O. BOX 770, Church Street Station, New York, NY, 10008-0770, US

(21) Appl. No.: 12/374,545

(22) PCT Filed: Jul. 20, 2007
(86) PCT No.: PCT/SG2007/000215

§ 371 Date: Jan. 21, 2009

Related U.S. Application Data
(60) Provisional application No. 60/832,193, filed on Jul. 21, 2006.

(51) Int. Cl. H02N 1/00; H02N 2/06

(52) U.S. Cl. 318/116; 310/300; 310/309

(57) ABSTRACT

Electrostatic microactuators are described in which stationary electrodes (4) and movable electrodes (3) mounted on flexures (6) have relative locations and mechanical properties such that non-linear pull-in/pull-out behavior is displayed when a voltage is applied between the stationary electrodes (4) and the electrodes do not come into contact. Larger electrostatic forces and longer travel ranges are achievable with lower applied voltages than typical microactuators. Further advantageous properties are obtained with the application of time-varying voltages with peak values exceeding the pull-in voltage and also at frequencies near a resonant frequency of the device. Several applications are described.

### REFERENCE TO RELATED APPLICATION

This application claims the benefit and priority of United States Provisional Patent Application entitled “Electrostatic Grating Actuator and Systems Thereof” filed Jul. 21, 2006 and assigned serial number U.S. 60/832,193, the entire contents of which are incorporated herein by reference for all purposes as if disclosed herein in their entirety.

### TECHNICAL FIELD

The present invention relates to the general field of electrostatic microactuators and, in particular but not exclusively, to non-contact electrostatic microactuators.

### BACKGROUND

Microactuators employing electrostatic forces are widely used in microsystems and play an important role in actuating microstructures such as micromirrors, variable capacitors, tunable RF (radio frequency) filters, among others. Microactuators also have important roles to play in sensing physical quantities, such as acceleration, pressure, among others. Examples of conventional microactuators and their applications have been described in many references.

The term “microactuators” is ordinarily used in the field to denote actuators whose operating components typically have dimensions in the order of one to many microns (micron=10⁻⁶ meter=μm), and/or for actuators intended to actuate microsystems. However, while it is believed that the subject matter discussed herein will find its primary applications in fields related to microactuators, this is not an inherent limitation. As is apparent to those in the field, many of the concepts described herein can be applied to actuators larger than microactuators and, in some cases, to actuators having characteristic dimensions smaller than microns and/or used to actuate nanosystems. For economy of language, this specification will refer to “actuators” or “microactuators” interchangeably, without implying thereby any particular size limitation either larger or smaller than microns.

It is convenient to consider microactuators in two general classifications: parallel plate microactuators including torsional actuators and comb-type actuators. Parallel plate microactuators typically contain one or more moving plates and one or more stationary plates with the moving and stationary plates attracting when a voltage is applied. It has been observed that when a movable parallel plate reaches the “pull-in height” or “pull-in separation” with respect to a stationary plate (typically about two-thirds of the initial separation), the movable plate suddenly attaches to the stationary plate. This electrostatic pull-in phenomenon was first reported in the late 1960s and pull-in separations and pull-in voltages were derived in closed-form mathematical expressions for some cases.

Since the initial reports, considerable research has been done designing microactuators and sensors making use of the pull-in phenomena. Detailed numerical simulations have appeared, typically employing finite element analysis. Recently, closed-form mathematical expressions have been derived relating separation, effective stiffness, resonant frequency, capacitance and their sensitivities to the applied voltage. Pull-in characteristics of one-degree-of-freedom torsional microactuators have been investigated with the intent of providing design guidelines for the pull-in angle and the corresponding voltage. The pull-in voltage and the corresponding angle and separation of two-degree-of-freedom torsional actuators were recently studied with a view towards understanding the nonlinear pull-in behavior as a function of an applied voltage. Such actuators based on parallel plates can typically generate a relatively large force at a relatively low applied voltage, possibly less than 10 V (volts). However, such actuators typically have the disadvantage of allowing only a relatively limited displacement, commonly about one-third of the initial separation because the pull-in phenomena causes the movable plate to mechanically contact the stationary plate or the substrate on which the device is mounted.

One motivation for the development of comb-type actuators (or “comb drive actuators” or simply “comb actuators”) was to avoid the pull-in phenomena and the resulting mechanical contact between the movable plate (or “electrode”) with the stationary (or “lower”) plate (or “electrode”). The comb drive actuator typically provides a constant force at a given applied voltage when the movable comb moves along the direction parallel to the comb fingers. Many microsystems, such as microgyroscopes, employ the comb drive to generate lateral motion with good linearity. However, the comb drive actuator typically has a small travel range even when high voltage is applied. To extend the travel range or to achieve the same travel range with a reduction of the applied voltage, many comb drive actuators operate at the resonant frequency or in a low-pressure condition such as a vacuum package.

Comb drive actuators utilizing a constant force at a given voltage have been suggested, one being to drive a micromirror. To actuate a micromirror, a vertically-supported comb shaped actuator may use a linearized electrostatic force. Although the comb drive actuator can actuate a vertically-supported structure, the actuator uses the linearized electrostatic force for small angular displacement.

A sandwich structure actuator may consists of comb-shape electrodes patterned on a movable solid plate suspended on a substrate, a gap, and counter comb-shape electrodes fixed on the substrate. This device may be used to precisely control position of the movable structure. However, in this sandwich structure actuator, the maximum displacement is limited to a displacement defined by the gap (formed between the movable and fixed electrode) minus the thickness of the movable plate. As a result, when the applied voltage of the sandwich structure actuator reaches a certain value, the movable plate mechanically contacts the fixed electrode.

Thus, a need exists in the art for a type of microactuator giving improved performance in one or more of the above performance characteristics and/or improved performance pursuant to other criteria as described elsewhere herein.

### SUMMARY

One exemplary aspect relates to an electrostatic microactuator comprising: at least one stationary electrode attached to a substrate; at least one flexure connected to the substrate; at least one movable electrode that is attached to the flexure and spaced from the stationary electrode; wherein the movable electrode is adapted to move toward the stationary electrode and to experience at least one of a pull-in phenomenon and pull-out phenomenon without mechanical contact with the stationary electrode when a sufficient voltage difference is generated across the movable electrode and the stationary electrode.

Another exemplary aspect relates to a non-contact electrostatic microactuator with non-linear pull-in/pull-out behavior producing relatively large electrostatic forces and longer travel ranges at lower applied voltages than typical electrostatic microactuators.

General configurations non-contacting stationary and movable electrodes are described as well as advantageous configurations of grating and slit structures using non-linear pull-in/pull-out behavior of the grating and slit structures that are electrostatically charged. Such actuators can exhibit relatively large displacements, and can be operated at any frequency of applied voltage as well as the resonant frequency. Such microactuators can also be operated at atmospheric since the typical total electrostatic force is large enough to overcome the spring force and the damping force due to air viscosity.

Embodiments of the present invention employ attractive electrostatic forces, repulsive electrostatic forces or both.

### BRIEF DESCRIPTION OF THE DRAWINGS

Exemplary and non-limiting embodiments will now be described with reference to the accompanying drawings in which:

FIG. 1 is a schematic perspective view of a typical grating microactuator (or actuator) pursuant to some embodiments.

FIG. 2 is a cut-away perspective view of the actuator of FIG. 1.

FIG. 3 is a perspective view of the fingers of the movable and stationary gratings of the actuator of FIGS. 1 and 2.

FIG. 4 depicts computed equipotential contour lines for the structure of FIG. 3 (two-dimensional view).

FIG. 5 depicts the computed capacitance per unit length between the movable and stationary gratings (a), and electrostatic force per unit length experienced by the movable grating (b).

FIG. 6 depicts the computed force per unit length: (a) comparison of Eq. 1.1 with simulated force; (b) the computed force of gratings with different geometry.

FIG. 7 is a schematic depiction of the final position taken by the movable grating for an applied voltage less than the pull-in voltage (a), and for an applied voltage at or exceeding the pull-in voltage (b).

FIG. 8 depicts the computed, dimensionless force curves (as function of dimensionless vertical separation H) acting on the movable grating of FIG. 7 for two values of the dimensionless initial vertical separation D of the stationary and movable gratings.

FIG. 9 gives the computed dimensionless height H as a function of the dimensionless force G for two values of dimensionless initial height D.

FIG. 10 is a graphical depiction of the relationship between dimensionless jump heights and dimensionless initial separation D.

FIG. 11 is a graphical depiction of the relationship between the initial dimensionless separation D and the dimensionless pull-in and pull-out forces Gₚᵢ and Gₚₒ.

FIG. 12 is a graphical depiction of calculated electrostatic and spring forces acting on the movable plate of the microactuator having the parameters of Table 1.

FIG. 13 is a graphical depiction of the calculated height of the movable grating of the micrbactuator having the parameters of Table 1.

FIG. 14 gives a schematic depiction of a typical displacement of the movable grating as a function of time (a) when the time-varying voltage of (b) is applied.

FIG. 15 gives a schematic depiction of a typical displacement of the movable grating as a function of time (a) when the time-varying voltage of (b) is applied.

FIG. 16 gives a schematic depiction of typical motion of the movable grating as a function of time (a) when the voltage of (b) is applied at the resonant frequency.

FIG. 17 is a schematic depiction of an equivalent mass-damping-spring model for the actuator of FIG. 1

FIG. 18 is a graphical depiction of the computed height of the movable grating in a microactuator with an applied voltage.

FIGS. 19(a) and 19(b) are graphical depictions of computed responses of the movable grating of a microactuator when two different ac voltages with dc biases are applied.

FIG. 20 is a graphical depiction of the computed response of the movable grating of a microactuator with an ac driving voltage and a dc bias voltage applied.

FIG. 21 is a schematic, perspective view of a repulsive microactuator used for charged particle detection.

FIG. 22 is a graphical depiction of typical behavior of the repulsive force between the moving and stationary electrodes in FIG. 21 as a function of the displacement or separation between the movable and stationary electrodes.

FIG. 23 is a schematic depiction of an equivalent model for the behavior of the actuator of FIG. 21.

FIG. 24 is a graphical depiction of repulsive and spring forces acting on the movable structures of FIG. 21 as a function of displacement, for various values of voltage.

FIG. 25 is a graphical depiction of the displacement of the movable structure of FIG. 24 as a function of voltage.

FIG. 26 is a graphical depiction of the time-varying displacement of the movable structure of FIG. 25.

FIG. 27 is a schematic depiction of a typical actuator for generating angular motion pursuant to some embodiments.

FIG. 28 is an upper, schematic depiction and schematic cross-sectional view of some embodiments having differing electrode geometries.

FIG. 29 is a schematic, perspective depiction of some embodiments including one or more proof masses so as to function as an acceleration sensor.

FIG. 30 shows the computed force vs. displacement for the accelerometer of FIG. 29 operating in its displacement mode.

FIG. 31 shows the computed force vs. displacement for the accelerometer of FIG. 29 operating in its resonance mode.

FIG. 32 shows computed force vs. displacement for the accelerometer of FIG. 29 operating in its voltage scanning mode, depicting in (a) Pull-in (jump δ1→δ2). (b) Jump (δ3→δ4).

FIG. 33 is a schematic cross-sectional depiction of a grating configuration before acceleration (a) and after acceleration (b) of an accelerometer pursuant to some embodiments.

FIG. 34 shows computed force vs. displacement for the accelerometer of FIG. 33, operated in the voltage scanning mode.

FIG. 35 is a schematic, perspective view of a typical microgyroscope pursuant to some embodiments.

FIG. 36 is a schematic, perspective view of a typical linear gyroscope.

FIG. 37 is a graphical depiction of time variations of vibrational amplitude, angular rotation rate and sensor signal for the linear gyroscope of FIG. 36.

FIG. 38 is a schematic, perspective view of a gyroscope that is not sensitive to the lateral shock.

FIG. 39 is a schematic, perspective view of a typical scanning micromirror pursuant to some embodiments.

FIG. 40 is a schematic side view and a schematic cross-sectional view along D-D of a mirror pursuant to some embodiments.

FIG. 41 is a schematic, perspective view of an exemplary grating light valve pursuant to some embodiments.

FIG. 42 is a schematic; cross-sectional depiction of typical operation of the grating light valve before voltage is applied (a), and after voltage is applied (b).

FIG. 43 is a schematic, cross-sectional view of an exemplary grating light valve pursuant to some embodiments.

FIG. 44 is a schematic, perspective view of an exemplary tunable capacitor pursuant to some embodiments.

FIG. 45 shows the calculated capacitance of the upper and lower grating system as a function of the applied voltage.

FIG. 46 is a schematic, cross-sectional depiction of an exemplary mechanical filter.

FIG. 47 is a schematic depiction of an equivalent model of the mechanical filter of FIG. 46.

FIG. 48 shows the computed output spectrum from the mechanical filter of FIG. 47 in the separate frequency mode (a), and the filter output as a summation (b).

FIG. 49 is a schematic, perspective depiction of an exemplary tuning fork.

FIG. 50 shows the computed spectrum of the tuning form depicted in FIG. 49 for two different bias voltages.

FIG. 51 is a schematic, perspective view of a microactuator as a component of a typical atomic force microscope (AFM).

FIG. 52 is a schematic, perspective view of two cells of an exemplary mechanical memory using a grating actuator with bistable lower gratings.

FIG. 53 is a schematic, cross-sectional depiction of the mechanical memory of FIG. 52 depicting principles of operation.

FIG. 54 is a schematic, perspective view of one cell of an exemplary mechanical memory using a carbon-nanotube grating actuator with bistable lower gratings.

FIG. 55 is a schematic, perspective depiction of an exemplary pressure-sensing device employing a typical grating actuator pursuant to some embodiments that can be used as a microphone, pressure or force sensor.

FIG. 56 is a schematic, perspective depiction of an exemplary tunable waveguide.

FIG. 57 is a schematic, cross-sectional depiction of typical modes of operation of the tunable waveguide of FIG. 56.

FIG. 58 is a schematic depiction of a typical fluidic mixer/resistance controller.

FIG. 59 is a schematic depiction of the working principle of the fluidic mixer/resistance controller of FIG. 58.

FIG. 60 is a schematic depiction of the working principle of a PCR processing device pursuant to some embodiments.

FIG. 61 is schematic depiction of a fluidic valve.

FIG. 62 is a schematic depiction of the working principle of the fluidic valve of FIG. 61.

FIG. 63 is a schematic depiction of a pump employing microactuator teachings pursuant to some embodiments.

FIG. 64 is a schematic perspective depiction of a typical DNA microarray.

FIG. 65 is a schematic depiction of the working principle of the DNA depicted in FIG. 64.

FIG. 66 is a schematic depiction of a typical optical measurement on a DNA microarray.

FIG. 67 is a schematic depiction of a typical image from a DNA microarray.

FIG. 67-1 is a schematic perspective depiction of a typical DNA microarray using nanotubes.

FIG. 68 is a schematic depiction of other possible microactuator configurations.

FIG. 69 is a cross-sectional, schematic depiction along axis E-E in FIG. 68.

FIG. 70 is a schematic, perspective depiction of an exemplary grating actuator for sensing multi-directional motions.

FIG. 71 depicts typical motions of the grating actuator of FIG. 70.

FIG. 72 is a cross-sectional depiction of FIG. 1 as a different embodiment.

FIG. 73 is a schematic, perspective view of a typical grating actuator pursuant to some embodiments with section G-G indicated.

FIG. 74 is a cross-sectional depiction along section G-G of FIG. 73 showing typical fabrication steps in FIG. 74a to FIG. 74j.

FIG. 75 shows SEM photographs of a fabricated microactuator.

### DETAILED DESCRIPTION OF EXEMPLARY EMBODIMENTS

After considering the following description, those skilled in the art will clearly realize that the exemplary embodiments disclosed herein can readily be utilized for the design and fabrication of electrostatic actuators and the use of such actuators in microsystems and/or microelectomechanical systems (MEMS) including, but not limited to microactuators, microsensors, radio frequency devices and optical microdevices.

As is conventionally understood, all numerical values of parameters given herein are subject to measurement uncertainties and imprecision. Thus, for economy of language it is understood that numerical values given herein are approximate within the conventional usage in the respective fields whether or not a particular value is explicitly stated to be “about xy” or “approximately xy”.

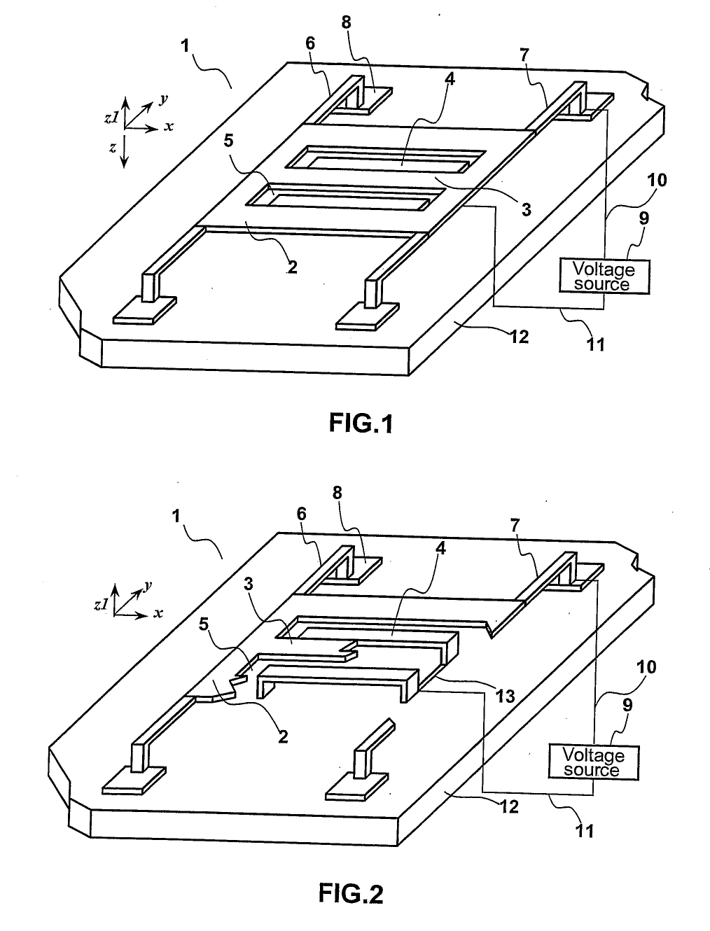

FIG. 1 depicts a typical example of an actuator pursuant to one example embodiment. A partial cut-away view is given in FIG. 2 more clearly depicting the stationary grating or structure lying beneath the movable grating or structure of FIG. 1. The exemplary actuator 1 depicted schematically in FIG. 1 includes a movable structure 2, typically a grating structure having one or more openings, attached to substrate 12 and supported by flexures 6 and 7. It is convenient, though not essential, in some embodiments to mount flexures 6, 7 on substrate 12 by means of anchors or anchor pads 8. A stationary grating 4 is mounted on substrate 12, typically between the movable grating 3 and the substrate 12 as depicted in FIG. 1, but this is not an essential feature.

As described in detail elsewhere herein, the embodiment disclosed is not limited to actuators having the general geometry depicted in FIG. 1 with a movable grating in proximity to a stationary grating. Furthermore, the embodiment disclosed is not limited to devices in which the fingers of the stationary and movable gratings have substantially rectangular shapes. Nor is the embodiment disclosed limited to actuators having substantially rectangular slits, 5, between the fingers of the gratings. However, it is believed that gratings and corresponding rectangular slits analogous to those depicted in FIG. 1 will prove to be advantageous structures for practical electrostatic actuators in many applications. Thus, to be concrete in this description, the specification will describe chiefly “grating actuators” or, equivalently, “slit actuators” not intending thereby to limit the embodiment disclosed to those particular shapes.

Some of the functions of the electrostatic actuator depicted schematically in FIG. 1 involve the application of a voltage difference between movable grating 3 and stationary grating 4. This source of applied voltage is depicted as 9 in FIG. 1, delivered to the actuator structure by connections 10 and 11. It is convenient for many embodiments for flexures 6 and 7 to be conductive and in electrical contact with movable grating 3, thereby allowing the voltage source 9 to be attached to one or more flexures as depicted in FIG. 1, connecting in that particular example, to a single flexure 7 by connection 10. However, this is not an essential limitation and poorly conducting or insulating flexures can be used and voltage delivered directly to movable grating 3 because there is no electrical current from the movable structure 2 to the stationary grating 4. Equivalently, electrical connection to one or more conducting flexures can be accomplished by connection through one or more conducting anchor pads 8. Connection 11 is used in this embodiment for applying voltage to stationary grating 4, but the actual contact is obscured from view in FIG. 1 but more clearly depicted in the cut-away view of FIG. 2.

FIG. 1 depicts one or more slits 5 in the movable grating 3 substantially aligned above the fingers of the stationary grating 4. While two slits are depicted in FIG. 1 located above two fingers of stationary grating 4, this is not an essential feature and one or more stationary grating fingers can be employed aligning with one or more slits in the movable grating. As discussed elsewhere herein, rectangular fingers and rectangular slits as depicted in FIG. 1 are for convenience and rectangular shapes are not an essential feature. Other shapes and arbitrary shapes are included within the scope of the embodiments herein and described elsewhere.

FIG. 2 is a cut-away view of the actuator of FIG. 1 giving a clearer view of one possible structure for the stationary grating 4. The stationary grating 4 is depicted as being elevated from substrate 12 and connected to voltage source 9 by wire 11. Elevation of the stationary grating 4 above the substrate 12 is useful, for example, in those applications in which the fingers of the movable grating 3 interleave with the fingers of stationary grating 4, when motions of the movable grating's fingers would be hindered by the positioning the stationary grating too close to the substrate. However, for those applications in which such interleaving do not occur, the fingers of the stationary grating can be closer to, or in contact with, the substrate. Also, if the substrate (as depicted in FIG. 2, for example) has a hole or pit under the movable grating, the stationary grating may be placed to bridge the hole or pit.

The particular embodiments depicted in FIG. 1 and FIG. 2 show the fingers of the stationary grating supported above the substrate by lifters formed by shaping the stationary grating fingers. This is an advantageous, but not an essential, configuration for the stationary grating. The stationary grating can be elevated above the substrate (when needed) by other suitable lifters, which need not necessarily be conductive, so long as an electrical connection not involving such nonconductive lifters is used, or another method is used to keep all fingers of the stationary grating at the desired electrical potential, such as direct connections to the voltage source.

FIG. 2 depicts wire 13 connecting the fingers of stationary grating 4, thereby keeping all fingers of the stationary grating at the potential of the applied voltage. However, any electrical connector between the fingers of the stationary grating that equalizes voltage between the fingers would be suitable. Of course, this issue becomes moot if the stationary grating contains only a single finger with electrical conductivity throughout its geometry.

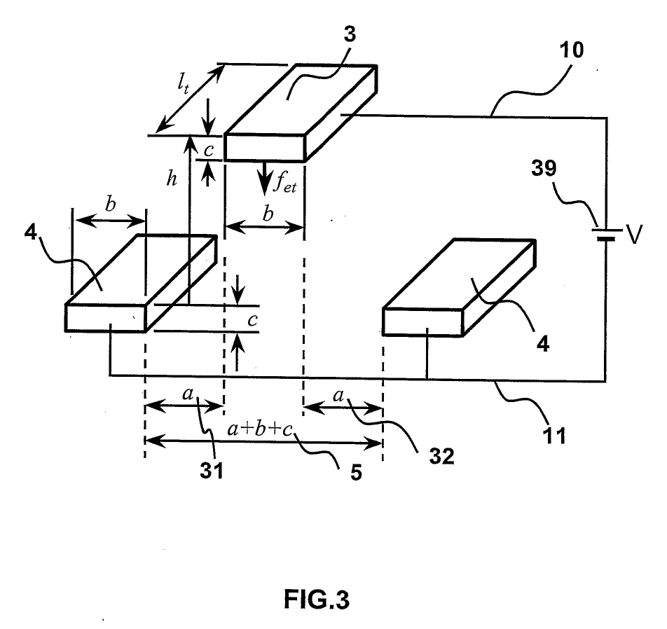

FIG. 3 is a schematic depiction of the central movable finger of the movable grating 3 of FIGS. 1 and 2, along with two of the stationary fingers of the stationary grating 4. The perspective view of fingers 3 are shown has having substantially rectangular shapes and having substantially the same sizes, including width “b” and thickness “c” in FIG. 3. While this is an advantageous property in terms of simulating, fabricating and/or using such an actuator, it is not an essential feature and differing shapes and/or sizes can also be employed. FIG. 3 also depicts movable finger 3 lying directly above stationary slit 5 and substantially centered. That is, slits 31 and 32 are substantially equal and have slit widths “a”. While this is an advantageous property in terms of simulating, fabricating and/or using such an actuator, it is not essential feature and differing shapes and/or sizes can also be employed.

The separation in the z1 or “vertical” direction or (pursuant to the coordinates shown in FIGS. 1 and 2) between the fingers of the movable and stationary gratings is denoted “h.” V denotes the voltage applied between the movable and stationary gratings. Iₜ denotes the length of the movable grating and fₑₜ denotes the electrostatic attractive force.

In general, when a voltage (39) V is applied across the movable and stationary gratings, an electrostatic force arises between the gratings that causes the movable grating structure to move toward the stationary grating, and may cause the movable grating to intervene or interpenetrate the stationary grating. In general, the electrostatic force, fₑₜ will be nonlinear, that is fₑₜ depends on the separation between the gratings, h, which changes in time.

In the vertical orientation depicted in FIGS. 1-3, the movable grating lies “above” the stationary grating and moves “downward” when attracted by the electrostatic force arising between the gratings. However, this is for convenience of expression since the orientation in space of the actuator is not limited to a vertical orientation and can be operated as depicted, inverted, or in any other desired spatial orientation.

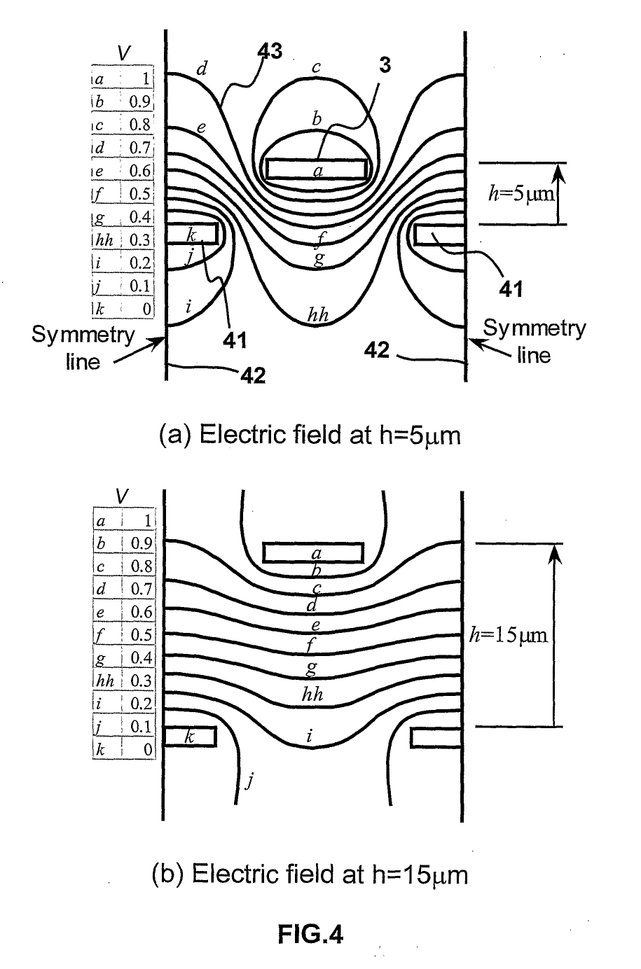

It is advantageous to increase the electrostatic force acting between the gratings by repeating periodically the slits and gratings in the horizontal or y-direction. In some of the simulations presented below the grating actuator consists of periodically repeated sequences of cells (in the y-direction), where each cell has substantially the structure depicted in FIG. 1 and FIG. 2. For simulation of the electrostatic forces, periodic boundary conditions are used in which the electric field is mirrored at the symmetry line 42 (FIG. 4).

### Computational Simulations

The Maxwell® 2D Electromagnetic-Field Simulation Software for High-Performance Electromechanical System Simulation, Version 3.1.04 (Ansoft Corporation, Pittsburgh, Pa.) was used to simulate the properties and behavior of the actuators. An error of 0.001% was used as the decision criterion for termination of the simulation.

FIG. 3 depicts in cross-section the general configuration used to examine the electrostatic force on the movable grating and the capacitance arising between the movable grating and the stationary grating. This simulation was performed using two fingers of the stationary grating and one finger of movable grating as depicted in FIG. 3 with periodic boundary conditions about the symmetry line (42 in FIG. 4). The two fingers of the stationary grating are fixed and the position of the movable grating is varied as measured by h. The applied voltage from the voltage source remains constant. The distances a, b, c of FIG. 3 were selected as follows: a=4 μm, b=8 μm, c=1.5 μm (μm=micron=10⁻⁶ meter). The numerical simulation is capable of calculating the capacitance between the movable and stationary gratings and the electrostatic force fₑ acting on the movable grating.

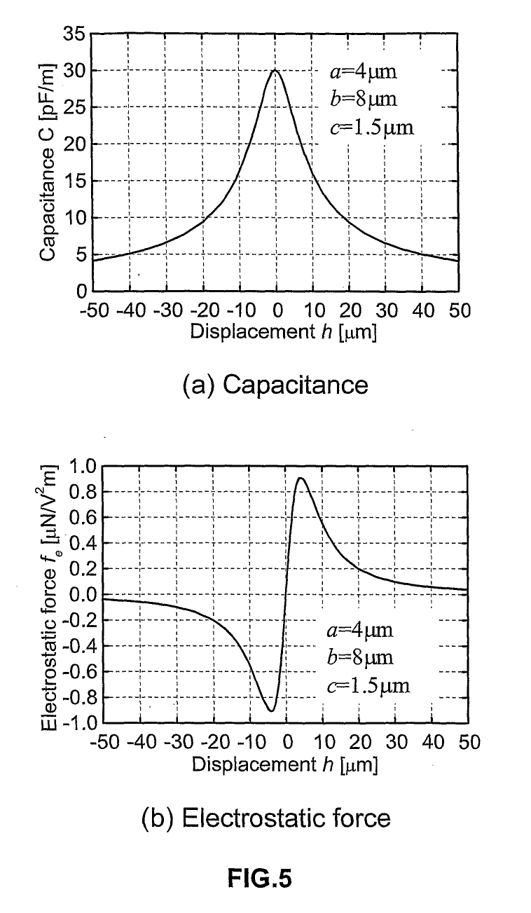

FIG. 4 depicts equipotential contours for the configuration of FIG. 3 (a=4 μm, b=8 μm, c=1.5 μm) when 1 Volt is applied for two values of the separation h. h=5 μm in FIGS. 4a and h=15 μm in FIG. 4b. The capacitance and electrostatic force per unit length acting on the movable grating (shown in FIG. 3) that is obtained from these calculations is given in FIG. 5 as a function h. It is observed that the force rapidly increases with h to a maximum near h=4 μm and then slowly decreases towards zero.

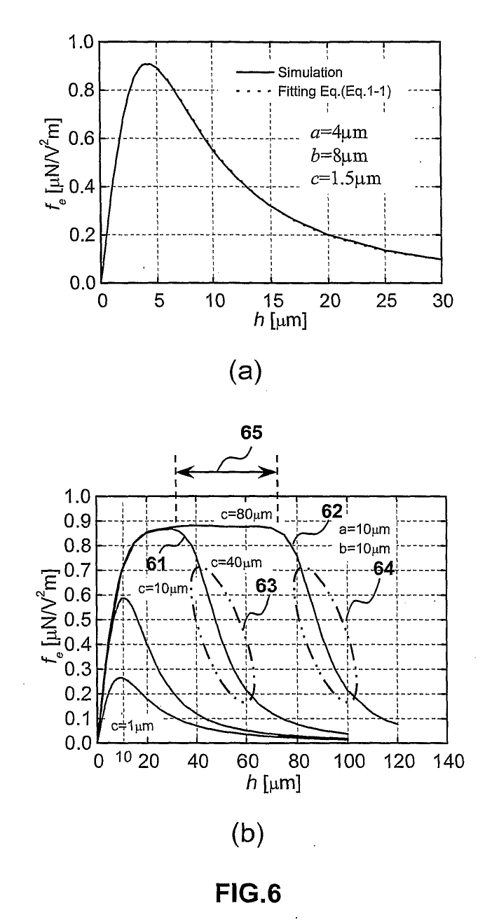

Typically, from a series of computer simulations of the general type depicted in FIGS. 5b, 6a and 6b, it is found that the height h at which the electrostatic force has its maximum value is close to the slit width a, that is dimensionless H=(h/a) is close to 1 if the grating thickness c is less than or equal to the slit width a (i.e. c/a=1). Furthermore, a smaller slit width generally provides a larger electrostatic force. The grating structure as generally depicted in FIG. 1 can be used as a displacement sensor since its capacitance is a function of the displacement h as shown in FIG. 5a. If the voltage source in FIG. 1 is replaced with a capacitance detector, the grating structure of FIG. 1 acts as a displacement sensor.

FIGS. 5a and 5b give the results of this simulation for the capacitance C and for the electrostatic force fₑ. In both cases, the capacitance C depicted in FIG. 5a, and the electrostatic force fₑ depicted in FIG. 5b, are presented scaled to units of per unit length of the stationary and movable grating fingers. (The parameter fₑₜ in FIG. 3 is the total electrostatic force between the movable and the stationary gratings.) The capacitance C, per unit length, is an even function of the parameter h about h=0 (FIG. 5a), and the electrostatic force fₑ, per unit length per square voltage, is an odd function of the parameter h about h=0 (FIG. 5b).

The electrostatic force fₑₜ on the movable grating can be obtained from the capacitance of FIG. 5a by standard methods. It is convenient to use the energy method to obtain fₑₜ as in Eq. 1:

$${f}_{et} = - \frac{\partial E}{\partial h} = - \frac{1}{2} \frac{\partial {C}_{t}}{\partial h} {V}^{2} \qquad Eq . 1$$

where E=CₜV²/2 is the electrical energy stored in the total capacitance (Cₜ) formed between the movable and stationary gratings. It is seen in Eq. (1) that fₑₜ is proportional to the partial derivative of the capacitance with respect to vertical separation h, and proportional to the square of the voltage.

For efficient mathematical manipulation, it is convenient to have a simple mathematical expression that approximates the force fₑ as a function of h depicted in FIG. 5b. It is found that the expression in Eq. 1.1 is conveniently used:

$${f}_{e} = \frac{{c}_{1} h}{1 + {c}_{2} {h}^{2} + {c}_{3} {h}^{4} + {c}_{4} {h}^{6}} \qquad Eq . 1.1$$

A numerical fit was performed for h in the range from 0 μm to 30 μm in FIG. 5b to obtain the parameters c₁, c₂, c₃ and c₄. The following values were obtained:

c₁=0.4060 N/V²m² Eq. 1.1a

c₂=4.667×10¹⁰/m² Eq. 1.1b

c₃=1.648×10²⁰/m⁴ Eq. 1.1c

c₄=−7.138×10²⁸/m⁶ Eq. 1.1d

in which N=force (in Newtons), m=distance (in meters) and V=voltage (in volts). This approximation to FIG. 5b is given in FIG. 6a. Since the force is antisymmetric about h=0, the same function can be used with a negative sign for values of h less than 0. A comparison of the approximate curve of FIG. 6a and Eq. 1.1 with the numerical simulation of FIG. 5b shows that the maximum error in the curve of Eq. 1.1 is 3.2% for the range 0≦h≦30 μm (and, therefore, for the range −30 μm≦h≦30 μm). FIG. 6b compares the electrostatic force acting on the movable grating as a function of the grating height c (in FIG. 3) when the widths (a and b) of the grating and slit remain constant (10 μm). When c is less than or equal to a (i.e. c/a≦1), the maximum force is obtained at about h=a(10 μm). For c/a>4, the electrostatic force has a flat force region 65 (of curve 62) and the right portions (63 and 64) of the curve 61 and 62 are almost the same shapes.

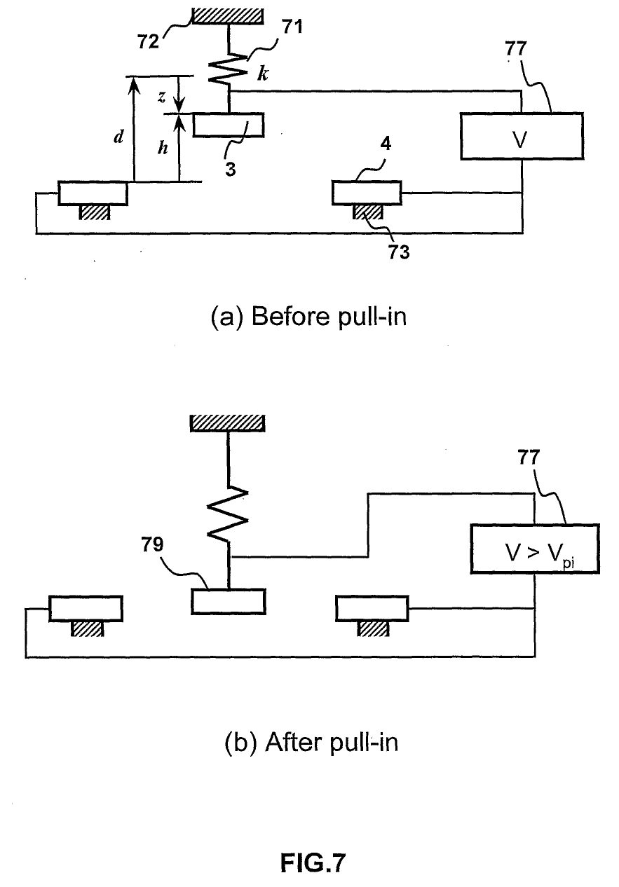

To assist in understanding the electro-mechanical behavior of electrostatic actuators of the general type depicted in FIG. 1, a model system was used as depicted schematically in FIG. 7a and FIG. 7b in which the various actuator elements correspond to those depicted in FIG. 3. For these simulations, the initial height of the movable grating above the stationary grating, d, is taken to be larger than a pull-in height (as described in more detail elsewhere herein). In FIG. 7a, the movable grating 3 is depicted as being subject to a spring-like substantially linear restoring force with spring force constant, or stiffness, k such that no restoring force is experienced when the movable grating is at its initial position, z=0. In FIGS. 7a and 7b, V denotes the applied voltage (which is typically varied in this simulation), Vₚᵢ denotes the pull-in voltage (as described in more detail elsewhere herein), z denotes the displacement of the movable grating from its initial position d, and h denotes the height of the movable grating above the stationary grating. That is, z is positive when the movable grating is below its initial position so that in FIG. 7a z+h=d. To begin the simulation, the movable grating 3 is placed far from the stationary grating 4 by a separation d and no applied voltage is applied, that is, z=0 and V=0 in FIG. 7a. Voltage from the voltage source 77 is applied and the movable grating moves in the direction of the stationary grating, or downward in FIG. 7a. When the applied voltage reaches the pull-in voltage Vₚᵢ, the movable grating 79 moves to a position between the stationary grating fingers, substantially as shown in FIG. 7b. When the applied voltage is reduced below a certain value, the movable grating returns to a position substantially as depicted in FIG. 7a, that is displaced from its position. In FIGS. 7a and 7b, the numbers, not explained, 71, 72 and 73 denote the spring and supports.

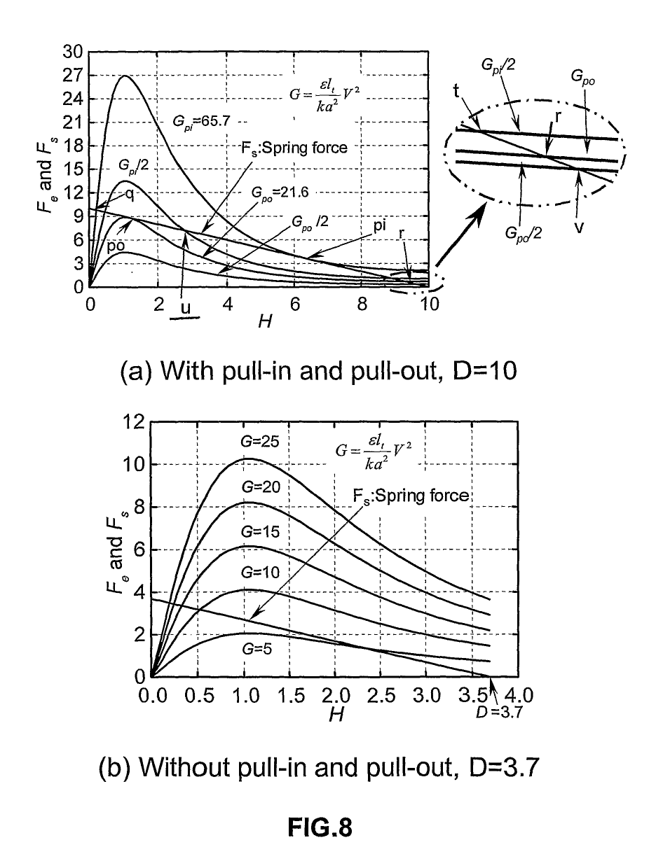

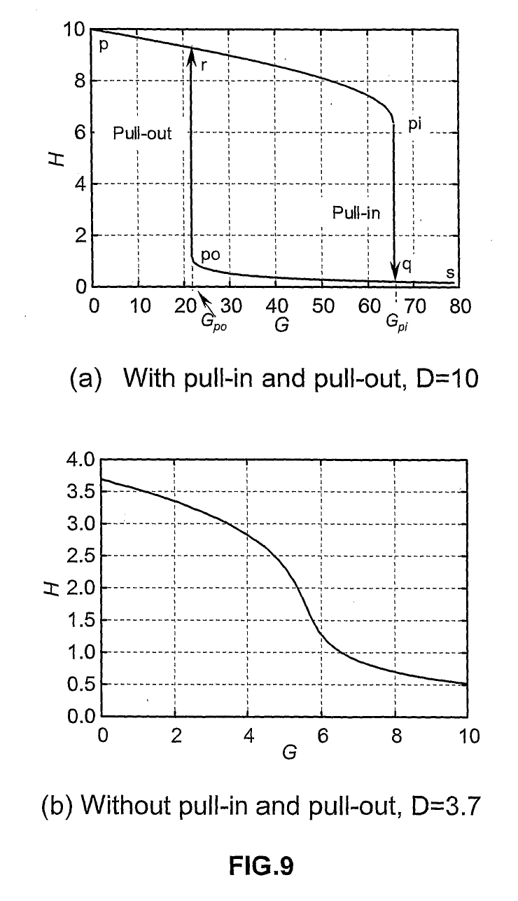

A better understanding of the behavior of the actuator depicted in FIG. 7 can be obtained by considering the plots of forces as functions of vertical separation h. These are shown in FIGS. 8 and 9 in terms of dimensionless parameters. The following useful quantities are defined:

$$\begin{matrix}{F}_{e} = \frac{Electrostatic force}{Characteristic force} = \frac{{f}_{e} {l}_{t} {V}^{2}}{\frac{ɛ {l}_{t}}{a} {V}^{2}} & Eq . 2 \\ {F}_{s} = \frac{Spring force}{Characteristic force} = \frac{kz}{\frac{ɛ {l}_{t}}{a} {V}^{2}} & Eq . 3 \\ \begin{matrix}G = Dimensionless electrostatic force \\ = \frac{Characteristic force}{ka} \\ = \frac{ɛ {l}_{t}}{{ka}^{2}} {V}^{2}\end{matrix} & Eq . 4 \\ H = \frac{h}{a} & Eq . 5 \\ D = \frac{d}{a} & Eq . 6\end{matrix}$$

where
fₑ=the electrostatic force of FIG. 3 per unit length per square voltage.
ε=the permittivity of air.
lₜ=the effective length of the slit.
a=the slit width formed between the movable and stationary gratings as in FIG. 3.
V=the voltage applied across the movable and stationary gratings.
k=the stiffness of the flexures.
h=the vertical separation (height) of the movable and stationary gratings.
d=the initial height of the movable grating.

The “characteristic force” is defined as εlₜV²/a, and is used to define dimensionless parameters related to the forces. Thus, the dimensionless parameters are as follows:
Fₑ=the (dimensionless) force at h and V.
Fₛ=the spring force.
G=the electrostatic force at voltage V.
H=the height of the movable grating.
D=the initial height of the movable grating.

FIGS. 8a and 8b give two examples of the behavior of the movable grating for two values of the initial height D, D=10 in FIG. 8a and D=3.7 in FIG. 8b. The force exerted by the spring Fₛ is a linear function of H as depicted in FIGS. 8a and 8b, and directed upward. Electrostatic forces Fₑ are calculated for a variety of values of applied voltages G and are also depicted in FIGS. 8a and 8b. For the positive values of H depicted in FIGS. 8a and 8b, the electrostatic forces are understood to be directed so as to cause the movable grating and the stationary grating to attract, that is, Fₑ is a downwardly-directed force. Also, for positive values of H, the spring force is upwardly-directed so as to separate the movable and stationary gratings. Both forces are depicted as positive in FIGS. 8a and 8b and, rather than use positive and negative forces for oppositely-directed forces, it is understood that the electrostatic and spring forces oppose for positive H. That is, the positive electrostatic force is the attractive force on the movable grating and the positive spring force is the restoring force.

Those values of H where the curve representing the spring force (upwardly-directed) intersects the curve representing the downwardly-directed electrostatic force represent conditions of zero net force on the movable grating, a condition that can be called a “solution” for the (at rest) position of the movable grating. However, different solutions need not have the same dynamical behavior. For example, some of these intersection points (solutions) represent stable conditions such that slight deviations from the intersection point cause forces to arise tending to restore the movable grating to its zero-force position. An example of a stable position is point q in FIG. 8a in which smaller values of H (downward displacements) lead to upwardly-directed spring forces larger than downwardly-directed electrostatic forces, tending to return the movable grating upward to point q. In other words, the point q is a stable position because the derivative of the restoring force (defined as the spring force minus the electrostatic force) with respect to the displacement z is positive. However, point u is an unstable solution where the derivative is negative. In FIG. 8a, the points pi and po are critical points where the derivative of the restoring force is zero.

Defining Gₚᵢ and Gₚₒ as the dimensionless pull-in and pull-out forces respectively, it can be seen in FIG. 8a for D=10 there is only one solution for G<Gₚₒ, namely the intersection point at the far right of FIG. 8a (shown in the expanded ellipse). This is indicated as point v for the case G=Gₚₒ/2. Likewise, there is only one solution for G>Gₚᵢ, namely the intersection point on the far left of FIG. 8a, analogous to point q. Point q is depicted for the case G=Gₚᵢ which also shows another solution at point pi. (Note, that for larger values of G, the curve displaces upward so the tangent point pi no longer touches the curve.) FIG. 8a shows two or three solutions for G in the range Gₚₒ≦G≦Gₚᵢ. For Gₚₒ<G<Gₚᵢ in FIG. 8a, two stable solutions are located at the largest and smallest values of H, such as points q, r, v and t. A solution occurring at an intermediate value of H (such as point u) is an unstable solution because it has a negative effective stiffness. That is, a slight displacement from the zero-force position at u, either upward (increasing H) or downward (decreasing H), causes unbalanced forces to arise in a direction causing further displacement.

For the values of G depicted in FIG. 8a two “jumps” are observed that are of particular interest, where a “jump” is a sudden movement of the movable grating from one location to another. The first jump that can occur is a sudden movement from (unstable) position pi to (stable) position q. This is the pull-in phenomenon that occurs in actuators pursuant some embodiments without mechanical contact occurring between the movable and stationary gratings. At pull-in position (q in FIG. 8a), the movable and stationary gratings are interdigitated without mechanical contact as shown in FIG. 7b. This is in contrast to the behavior of conventional parallel plate actuators in which the pull-in causes the mechanical contact of the movable plate with the stationary electrode or substrate.

The second jump of interest occurs from point po to point r and also occurs without mechanical contact. Physically, when the applied voltage is reduced, the interdigitated movable and stationary gratings (FIG. 7b) are suddenly released without mechanical contact at the point po. This behavior can be defined as “pull-out” behavior or phenomenon, an opposite concept from that of the pull-in phenomenon.

FIG. 8b, in which D=3.7, shows only one solution for any value of G.

The examples depicted in FIGS. 8a and 8b illustrate that parameters related to pull-in and pull-out phenomena (e.g. pull-in voltage, pull-in height, etc.) are functions of the dimensionless initial height D. More detailed numerical analysis using the electrostatic and spring forces shows that the minimum D for which pull-in and/or pull-out behavior can be found is D=4.3 for the geometry a=4 μm, b=8 μm, and c=1.5 μm and the corresponding force as depicted in FIG. 5b.

FIGS. 9a and 9b show the heights of the movable grating as a function of electrostatic force corresponding to FIGS. 8a and 8b. For D=10 (FIG. 9a), the movable grating experiences the pull-in and pull-out phenomena at G=Gₚᵢ and G=Gₚₒ, respectively. For D=3.7, FIG. 9b depicts the height of the movable grating as a function of G. As mentioned above, D=3.7 is less than the minimum value of D (D=4.3) for which pull-in and pull-out occur. The height is seen to decrease relatively slowly for G in the range from 0 to approximately 4. H is seen to decrease more rapidly in the range from approximately 4 to approximately 7, but reverts to relatively slow decrease for G larger than about 7. Even though FIG. 9b does not depict an abrupt change in height characteristic of pull-in and pull-out behavior, the relatively rapid change in H for G in the range from about 4 to about 7 can still be used for actuators or sensors that require relatively large changes in height and/or capacitance. In addition, the sensitivity of H to G depends on the dimensionless initial height D, so that the height at a particular applied voltage, the sensitivity of the height to the applied voltage, the pull-in and pull-out heights, and the corresponding voltages are functions of the geometry and the stiffness.

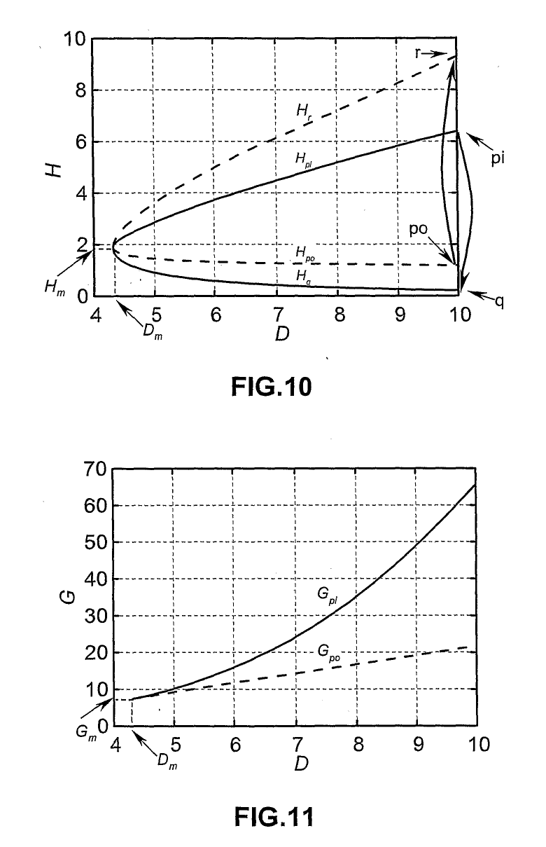

FIGS. 10-11 show heights and forces at pull-in and pull-out positions obtained by computer simulations simulated by using the data of Table 1 and Eq. 1.1. FIG. 10 depicts the dimensionless heights at pull-in, pull-out and their jumping positions as functions of the dimensionless initial height D. In FIG. 10, Hₚᵢ, H_{q}, Hₚₒ, Hᵣ, Hₘ, and Dₘ denote the pull-in height, the jumping height from Hₚᵢ, the pull-out height, the jumping height from Hₚₒ, the minimum critical height, and the minimum dimensionless distance for the pull-in and pull-out, respectively. It is noted from FIG. 10 that the minimum critical height Hₘ appears at Dₘ and splits into the pull-in height (Hₚᵢ) and the pull-out height (Hₚₒ). The jumping heights (H_{q}, Hᵣ) also start from Hₘ and divide into two separate curves. In FIG. 10, D=10 and corresponding heights are used to understand the behavior of the movable grating as the dimensionless force varies. As the applied voltage V of FIG. 7 increases, the corresponding dimensionless force increase and the dimensionless height decreases from 10 to the pull-in height Hₚᵢ of FIG. 10. The movable grating jumps from Hₚᵢ to H_{q} and decreases with increasing G. When the applied voltage (i.e. dimensionless force) decreases, the movable grating moves through H_{q} and reaches the pull-out height Hₚₒ. The movable grating returns from Hₚₒ to Hᵣ and then the height H increases with decreasing G. The dimensionless pull-in and pull-out forces G corresponding to Hₚᵢ and Hₚₒ in FIG. 10 are shown in FIG. 11. At Dₘ=4.3, Gₚᵢ and Gₚₒ start from Gₘ=7.4 and divide into two graphs (Gₚᵢ and Gₚₒ). Gₚᵢ increase to 65.7 at D=10 while Gₚₒ reaches 21.6 at D=10.

These pull-in and pull-out phenomena are essentially due to the inherent severe nonlinearity of the electrostatic force (e.g. FIG. 5b) of the grating actuator, such as that depicted in FIG. 1. Furthermore, for the grating actuator structure pursuant to some embodiments, pull-in and/or pull-out occur without mechanical contact. This is a particularly advantageous characteristic of the grating actuator pursuant to some embodiments in that the stiction problem common in many parallel plate devices is avoided.

TABLE 1
Design parameters of a grating microactuator
Slit, movable and stationary gratings

| | |
|---|---|
| Slit width, a | 4 × 10⁻⁶ m |
| Grating width, b | 8 × 10⁻⁶ m |
| Grating thickness, c | 1.5 × 10⁻⁶ m |
| Length of the gratings, lₜ | 8.3 × 10⁻³ m |
| Initial height between the movable and stationary | 18 × 10⁻⁶ m |
| gratings, d | |

Flexures for spring

| | |
|---|---|
| Number of flexures, n | 4 |
| Length, l | 197 × 10⁻⁶ m |
| Width, w_{b} | 4 × 10⁻⁶ m |
| Thickness, t | 1.5 × 10⁻⁶ m |
| Stiffness of the four flexures, k | 0.194 N/m |

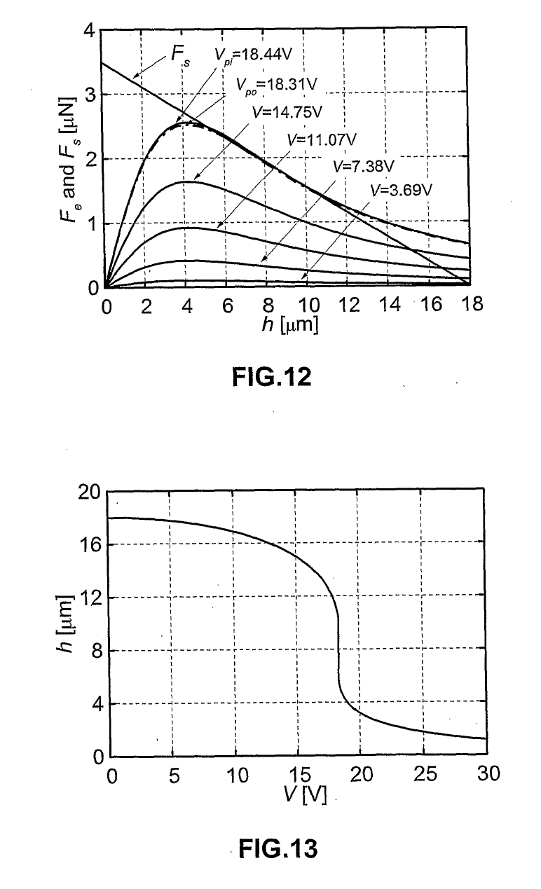

A microactuator was designed using parameters listed in Table 1. The slit width (a), the grating width (b) and thickness (c), and stiffness were selected as 4 μm, 8 μm, 1.5 μm, and 0.194N/m, respectively. The dimensionless initial height is calculated as 4.5 which is greater than the minimum Dₘ (4.3) obtained from FIG. 10. Thus, it is expected that the microactuator fabricated with these parameters will demonstrate both pull-in and pull-out phenomena. FIGS. 12 and 13 show the forces acting on the movable grating and its height respectively when the voltage, applied across the movable and stationary gratings of the designed microactuator (Table 1), increases from zero. In FIG. 12, the electrostatic force increases with the voltage while the spring force curve is not changed. The pull-in and pull-out voltages are 18.4V and 18.3V, respectively, and the corresponding pull-in and pull-out heights are 10.2 μm and 5.7 μm, respectively. The height of the movable grating is seen to be very sensitive to the voltage in the vicinity of the pull-in and pull-out voltages. FIG. 13 clearly shows the dependence of this height on the voltage. When the applied voltage increases from 0 V to 30V, the height of the movable grating decreases, jumping from 10.2 μm to 5.4 μm at the pull-in voltage of 18.4V. The height then slowly decreases with increasing voltage. When the voltage decreases from 30V to zero, the movable grating demonstrates the pull-out effect at a pull-out voltage of 18.3V at which point the height suddenly changes from 5.7 μm to 10.5 μm.

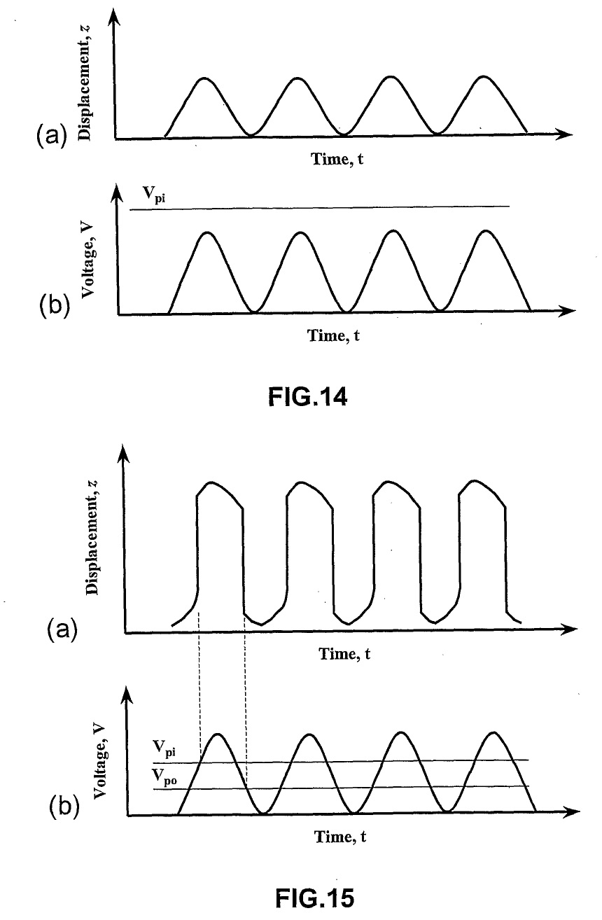

For easy understanding of the behavior under time-varying applied voltage, FIGS. 14-16 are shown as brief sketches based on the height (FIG. 9a) under applied voltage.

FIG. 14a shows the time variation of the displacement of the movable grating resulting from the application of a time-varying voltage (depicted in FIG. 14b) for the case in which the applied voltage never exceeds the pull-in voltage Vₚᵢ. In this case, the displacement of the moving grating follows the applied voltage.

FIG. 15a shows the time variation of the displacement of the movable grating resulting from the application of the time-varying voltage depicted in FIG. 15b. In this case, the applied voltage exceeds the pull-in voltage for a portion of its cycle such that the displacement of the movable grating jumps to a new position when the applied voltage rises to a value of Vₚᵢ then follows the displacement curve pi-q-s-po in FIG. 9a. Another jump to another position occurs at Vₚₒ. Finally, the displacement follows the displacement curve (po-r-p-pi in FIG. 9a). It is clear from FIG. 15 that large displacements can be made to occur if the applied voltage is larger than the pull-in voltage.

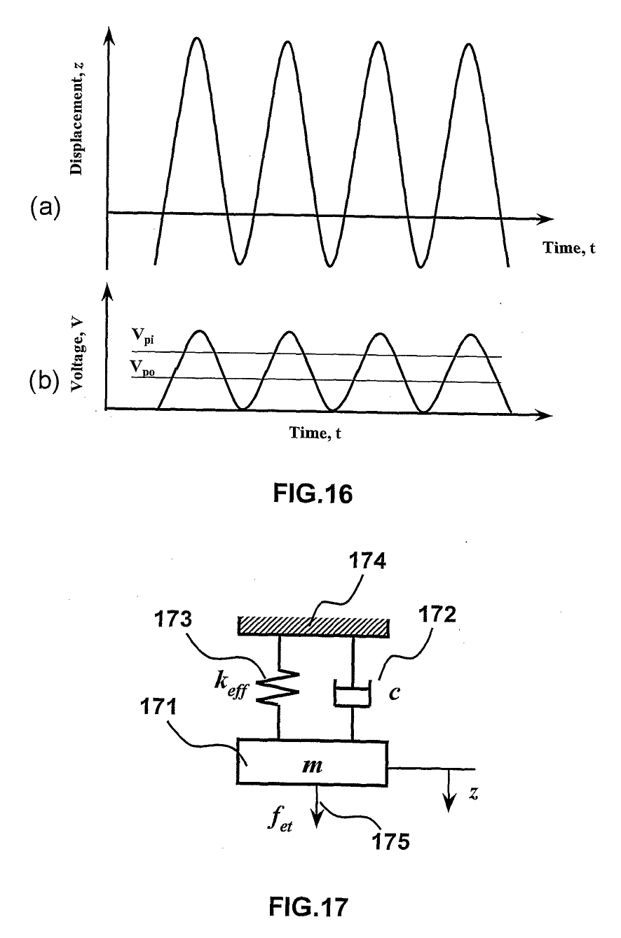

When voltage above or close to the pull-in voltage is applied at a resonant frequency of the grating actuator, a resonance of the movable grating is observed as shown in FIG. 16. At the resonant frequency, the displacement is larger than that at lower frequency, as depicted in FIG. 15.

As depicted in FIGS. 14, 15, and 16, different behavior of the actuator can be obtained when voltages in one of the three activation modes are applied: (1) Never exceeding the pull-in voltage, (2) Exceeding the pull-in voltage but not near a resonant frequency of the actuator, and (3) Exceeding the pull-in voltage and applied at or near a resonant frequency. The behavior without pull-in and pull-out phenomena was also used. For example, if a grating actuator with slow or rapid change of height (without pull-in) was needed, some portions of the curve of FIG. 9b may be used. It is convenient to describe these dynamic responses of the grating actuator with a model consisting of a spring, a mass, and a damper, and the electrostatic force is applied to mass. This is depicted schematically in FIG. 17.

In FIG. 17, the mass 171 of the movable grating suspended from a foundation 174 is denoted by m. fₑₜ is the electrostatic force 175 on the movable grating. k_{eff} is the effective stiffness 173 reflecting the flexure stiffness and the electrical stiffness. The damping coefficient 172 is given by c. The displacement is given by z. Using this dynamic model, the following equation was obtained that governs the motion of the movable grating driven by an AC voltage Vₐ with a bias voltage V_{b}.

$$m \frac{{d}^{2} z}{d {t}^{2}} + c \frac{d z}{d t} + {k}_{eff} z = {f}_{et} = {f}_{e} {l}_{t} {V}^{2} = {f}_{e} {{l}_{t} ( {V}_{b} + {V}_{a} sin ω t )}^{2} \qquad Eq . 7$$

where ω is the angular frequency of the applied AC voltage. If the above equation is linear for small z, its steady state solution is obtained as follows:

z=A sin(ωt−φ) Eq. 8

where A and φ are amplitude and phase that are functions of the mass, the damping coefficient, the effective stiffness and the applied force amplitude. It is noted from FIG. 17 that the effective stiffness k_{eff} is defined as the stiffness difference (i.e. derivative of the restoring force with respect to the displacement z in FIG. 7a). Therefore the effective stiffness and resonant frequency are functions of the applied voltage. The effective stiffness and resonant frequency can be adjusted when the applied voltage is controlled. The effective stiffness increases or decreases depending on the voltage or dimensionless force G as shown in FIGS. 8a and 8b. The resonant frequency can also be adjusted since the resonant frequency is a function of the effective stiffness. As the applied voltage becomes large, Eq. 7 can be considered as a nonlinear differential equation whose solution can be obtained by using a numerical analysis.

The motion of the movable grating may be a combination of transitional or torsional motions. In one form, the motion is linear. In another form the motion is torsional.

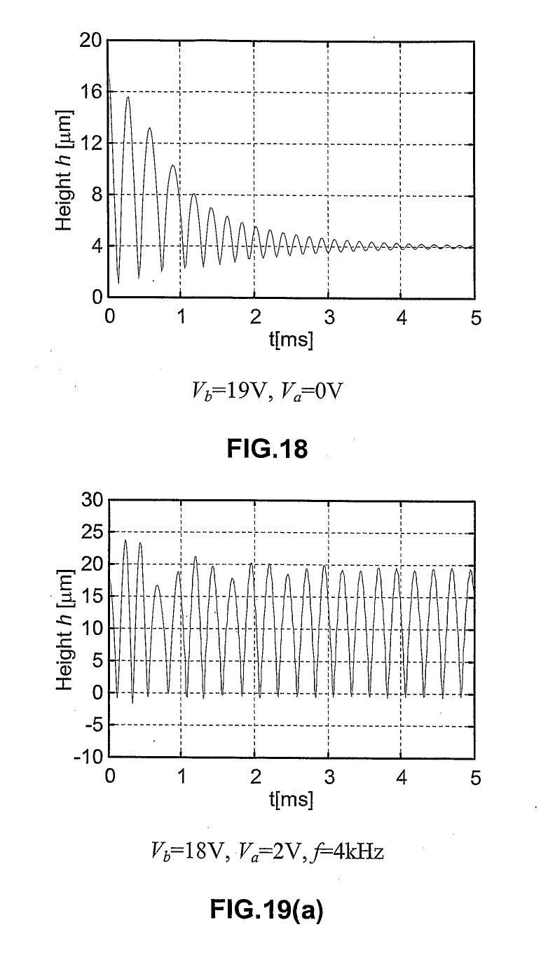

The behavior of the movable grating is simulated by using Park's method, one of the stable methods for solving nonlinear second order differential equations. For the numerical simulation, it was assumed that the damping coefficient of the microactuator is 2.9×10⁻⁷ N-sec/m, corresponding to a quality factor of 20. FIG. 18 depicts the simulated dynamic response when a DC voltage of 19V is applied to the microactuator. The height of the movable grating quickly decreases from 18 μm to 1.08 μm. Its vibration amplitude decays with time, and the height approaches the theoretical height of 4.05 μm that corresponds to the height resulting from V=19V in FIG. 13.

FIGS. 19a and 19b show the heights of the movable grating with respect to time when AC drive voltage (Vₐ) with DC bias voltage (V_{b}) is applied to the actuator at a frequency (f). FIG. 19a depicts the height for V_{b}=18V, Vₐ=2V, and f=4 kHz and FIG. 19b shows the response for V_{b}=19V, Vₐ=2V, and f=4.5 kHz. The corresponding RMS (root mean square) voltages are 18.05V (less than Vₚᵢ=18.4V in FIG. 13) and 19.05V (greater than Vₚᵢ), respectively. Both cases produce reasonably large vibrational amplitudes, typically more than 20 μm as shown in FIGS. 19a and 19b.

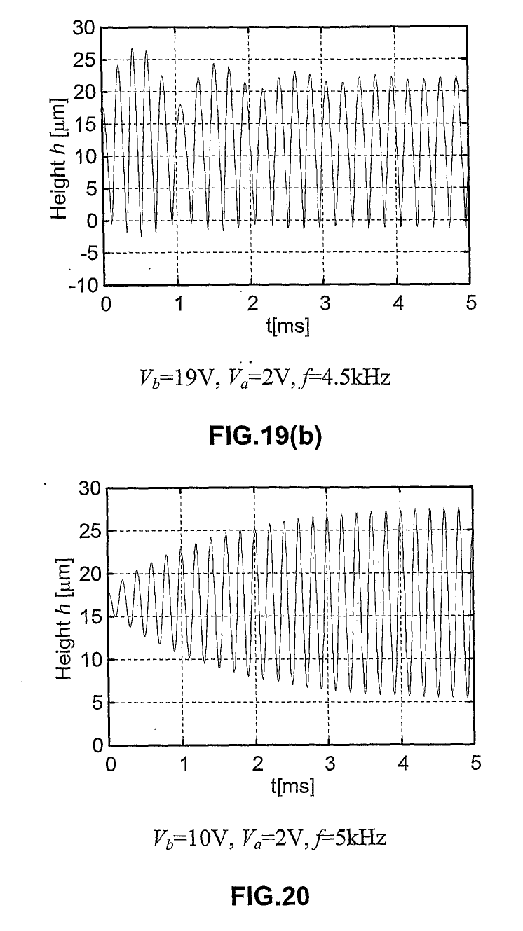

FIG. 20 depicts a simulated height of 23.2 μm when an AC driving voltage of 2V with DC bias voltage of 10V drives the movable structure at the resonant frequency (5 kHz) of the structure that is a function of the applied voltage. For c≦a, the height at the peak of the electrostatic force (FIG. 6a and FIG. 6b) is almost the slit width a (i.e. h at peak in FIG. 6a is approximately equal to a), and a smaller slit width provides a higher electrostatic force. Therefore, if a lower initial height and a smaller operating voltage is desired, one can use smaller slit widths (a) and use flexures with lower stiffness. Smaller slit width (e.g. a=2 μm) produces an electrostatic force curve (similar to FIG. 6a) with a higher peak. This more favorable force curve yields lower voltages V and smaller initial heights d.

Detection of Charged Particles with Repulsive Microactuator using Gratings Actuator

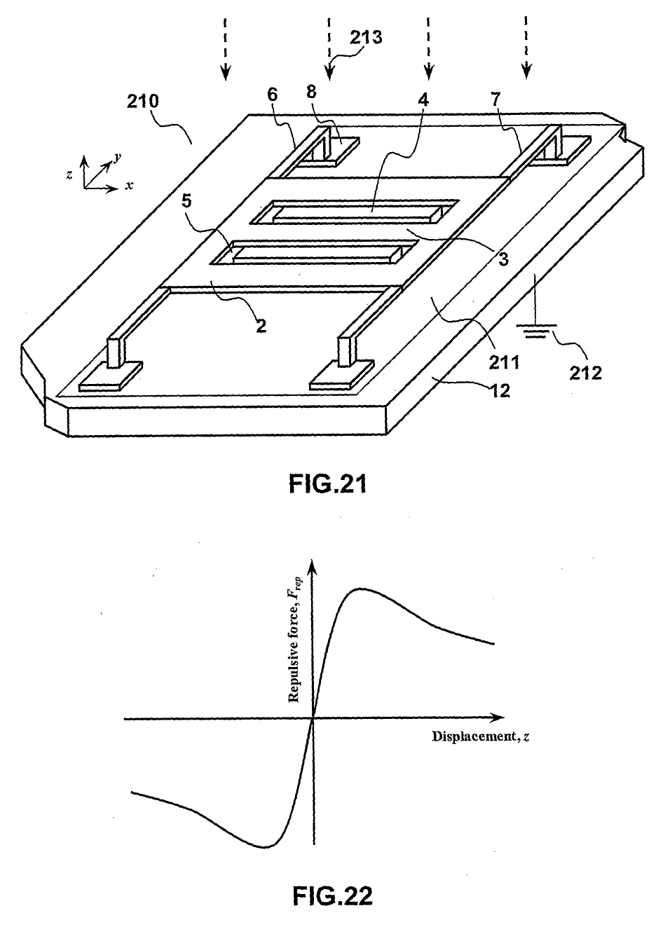

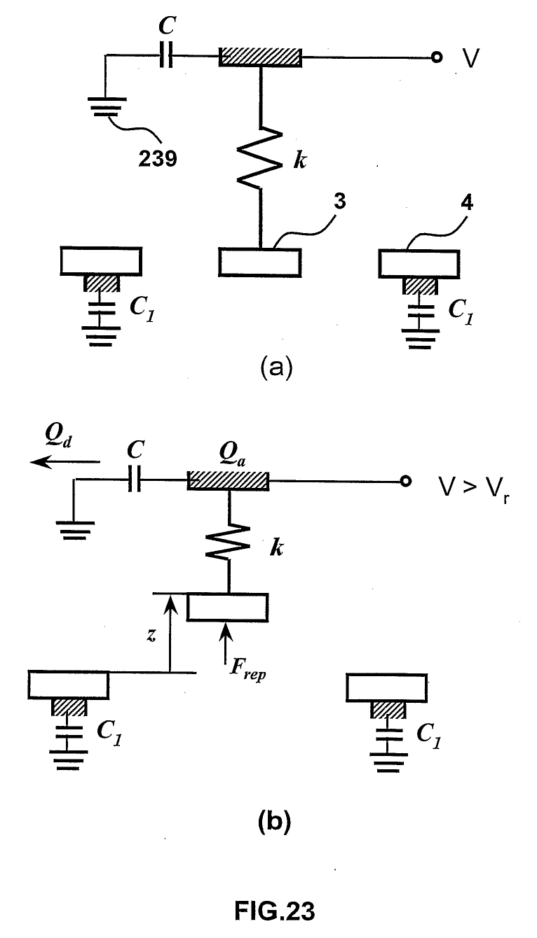

The pull-out or repulsive microactuator behavior described herein can be employed to construct a charged particle detector, electroscope or DNA sensors for DNA hybridization measurements. FIG. 21 depicts a microactuator similar to that depicted in FIG. 1, mounted on an insulator 211 and surrounded by a conducting collar 12. In FIG. 21, the same numbers are assigned if the parts play the same roles as those in FIG. 1. When the actuator of FIG. 21 is bombarded by charged particles, electrons can be dislodged and removed from the movable and stationary electrodes causing both to become positively charged (or negatively charged depending on the properties of the bombarding particles). The like charges of the moving and stationary electrodes cause a repulsive force to arise between movable and stationary structures. The electrostatic force on the movable structure of FIG. 21 is depicted in FIG. 22, obtained through computational procedures as discussed above in connection with FIG. 5b and shown as a function of the vertical displacement or separation between the movable and stationary structures. FIGS. 23a and 23b illustrate the working principles of the actuator of FIG. 21 for the case in which the voltage is less than the return voltage (23a), and the case in which the voltage is greater then or equal to the return voltage. In FIGS. 23 (a) and (b), C denotes the capacitance formed by the sandwich of the anchor 8 (FIG. 21), the insulator 211, and the conductive collar 12 and C₁ is the capacitance formed by the stationary structure, the insulator 211, and the conductive collar 12. The capacitances C and C₁ can be determined by the overlapping area, the insulator thickness, the insulator material. The tunneling current and voltage are a function of the insulator thickness and the material properties of the insulator.

When the movable and stationary structures are initially coplanar (i.e. z=0) and charged, FIG. 22 shows the repulsive force acting on the movable structure in the z direction with respect to the displacement z. The repulsive force starts at zero, rapidly increases to a maximum value and decreases with the displacement z. FIGS. 23a and 23b shows the working principle of the electrostatic repulsive actuator using slits shown in FIG. 21. In FIGS. 23a and 23b, C, C₁, k, V, Vᵣ, Qₐ, Q_{d}, z and Fᵣₑₚ denote the capacitance formed between the movable structure and the conductive collar, the capacitance formed between the stationary structure and the conductive collar, the stiffness of the flexures in FIG. 21, the voltage of the movable structures, a return voltage (critical voltage), the accumulated charge on the movable structure, the amount of discharge at Vᵣ, the displacement of the movable structure, and the repulsive force acting on the movable structure, respectively. The numbers 3, 4, and 239 denote the movable and stationary gratings and the earth.

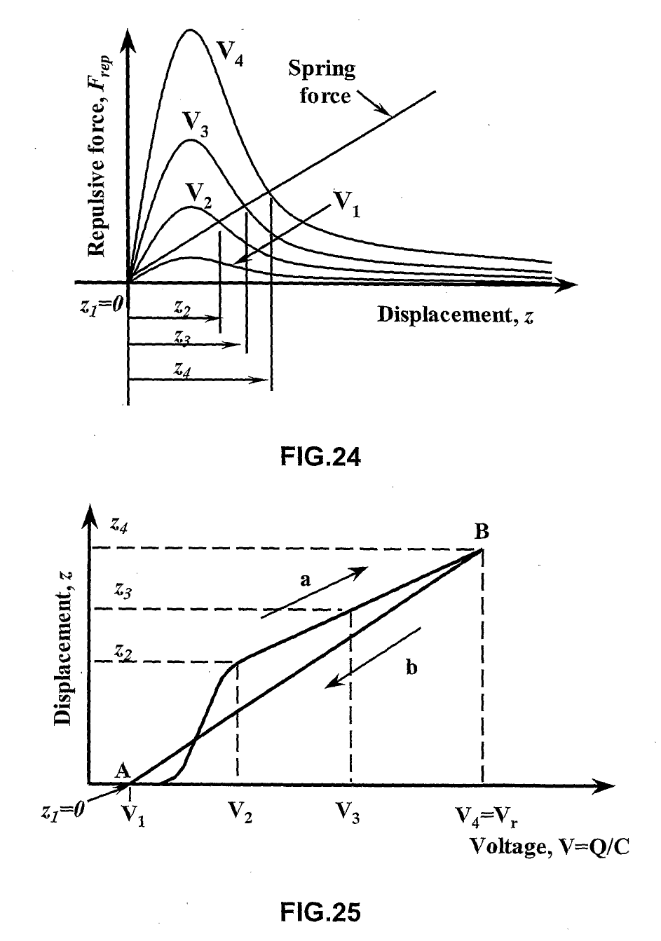

When charges accumulate on the movable and stationary structures, the voltage across capacitance C increases from zero and reaches the return voltage that causes tunneling (or break down) of charge through the insulator. The charge reduces from Qₐ to Q=Qₐ−Q_{d} due to the discharge Q_{d} and then the voltage decreases. The stationary structure may also experience charging and discharging while exposed to the radioactive material. The repulsive force acting on the movable structures is a function of the amount of the charge or voltage. The repulsive force is proportional to QaQb where Qb is the charge on the stationary structure. FIG. 24 depicts the repulsive and spring forces on the movable structures when the voltage or charge is changed. When the voltage increases from V₁ to V₄, the displacement is changed from z₁ to z₄. FIG. 25 shows the displacement of the movable structure as a function of the voltage. Due to the accumulated charge, the voltage increases along zero, V1, V2, V3 and V4 and the corresponding displacement varies along zero, z1, z2, z3 and z4. If the voltage V4 reaches the return voltage, the insulation layer between the movable structure and the substrate allows the discharge Q_{d} and then the voltage decreases from V₄ to V₁. The corresponding movable structure moves from z₄ to z₁.

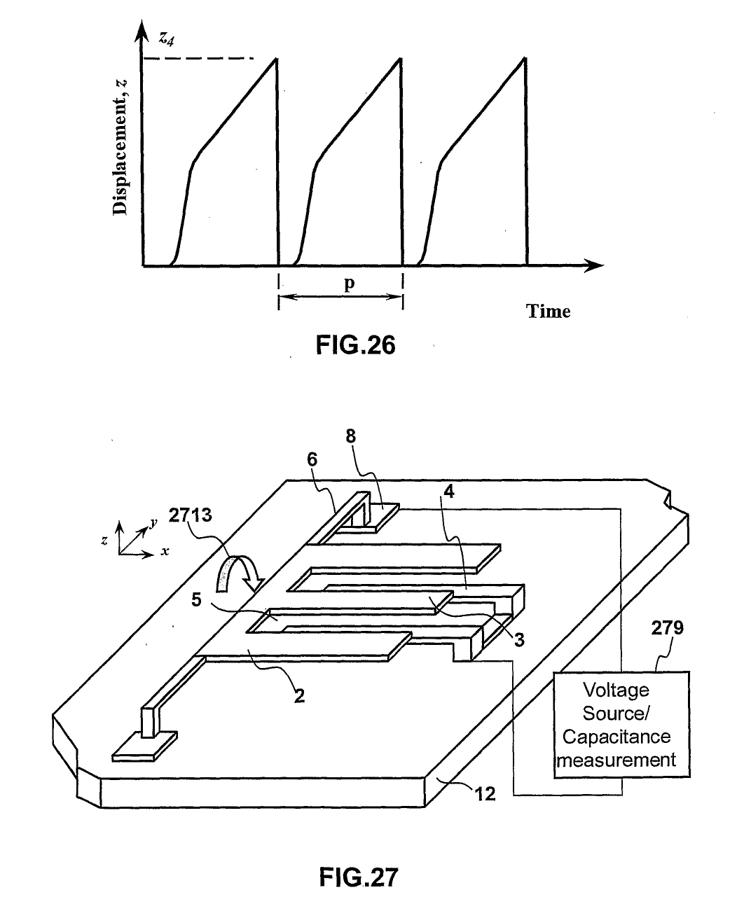

Therefore, when the microactuator of FIG. 21 is exposed to a radioactive material, the displacement of the movable structure repeat z₁ and z₄ along the curves a and b. FIG. 26 shows the response of the repulsive force microactuator with respect to time. The movable grating is displaced by maximum z₄ and vibrates with a period p. The corresponding frequency is defined as f=1/p. The vibration frequency of the movable structure along the curve a and b is related to the intensity of radiation of the radioactive material. Therefore, when the frequency is measure by a measurement means, the radiation intensity of the radioactive material may be obtained. Any measurement means can be used to measure the frequency. For example, an optical method can be used for the frequency or displacement measurement. If the charged particles are only injected for short time, the movable grating does not vibrate but is displaced by a displacement due to the constant charge accumulated. FIG. 25 is a conceptual graph to briefly explain the basic working principle of the repulsive actuator described here. If the capacitance C1 experiences tunneling, the graph will become much more complex. However, charging and discharging of the capacitance of the repulsive actuator gives essentially the same phenomena (displacement or vibration of the movable structure). When the same structure is exposed to electrostatically charged material or to an electric field, the opposite charges are induced on the movable and stationary structures and the movable structure moves as shown in FIG. 24. Therefore the microactuator can be used as an electroscope. Any modified structures using the same working principle can be used for the charged particle or electric field. For example, a modified structure consisting of movable and stationary comb structures: the movable come structure is suspended by flexures (e.g. cantilever) and is displaced by a predetermined distance from the stationary comb structure placed on a thin insulator. If the modified structure is exposed to charged particles, the movable comb structure is linearly or angularly displaced, and then the displacement can be measured by a measurement means (e.g. optical or capacitance detection). In FIG. 21, the movable and stationary structures are placed on the insulator sitting the conductive collar to form the capacitances C and C₁ between the structures and the conductive collar 12. If the movable and stationary structures are covered with an insulator and are sitting on the conductive collar 12 and exposed to charged particles, the charge accumulates on the insulator and causes the repulsive force already mentioned. As a result, the structures covered with insulator can be used a repulsive actuator that detects and measures charged particles or electric fields.

### Examples of Actuator Uses

The grating actuators described elsewhere herein can be used in many microsystems, including but not limited to, the following: accelerometers, gyroscopes, mirrors, scanners, grating light valves, tunable capacitors that can adjust the capacitance mechanical filters, mechanical memories, microphones and optical wave-guides.

FIG. 27 is schematic depiction of embodiments to generate angular motion 10. In FIG. 27, the same numbers are assigned if the parts play the same roles as those in FIG. 1. When the voltage from the voltage source is applied across the upper and lower gratings (3 and 4), the upper, movable grating 3 rotates towards the lower, stationary grating 4 to generate angular motion 2713. Characteristics described elsewhere herein such as pull-in and pull-out phenomena are also observed. Capacitance can be measured by capacitance measurement mean 279 to detect the angular motion.

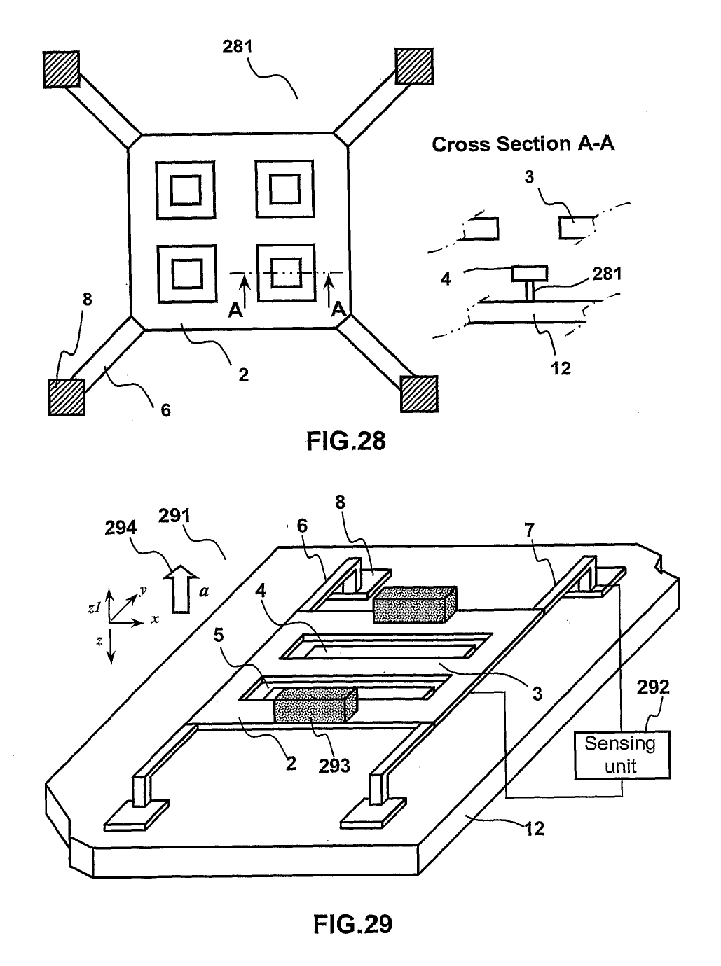

The particular embodiments described thus far have depicted rectangular grating structures for convenience. However, the embodiments herein are not limited to rectangular gratings and, indeed, virtually any shape of electrodes can be used in actuators employing the principles described herein. For example, FIG. 28 depicts an actuator using square electrodes 3 and 4. In FIG. 28, the same numbers are assigned if the parts play the same roles as those in FIG. 1. The upper electrode 3 with square holes is spaced far from the square lower electrodes 4 by a predetermined distance. When voltage is applied the upper and lower electrodes, the upper electrode moves downwards due to the electrostatic force.

When grating actuators are used in some applications, displacement sensors may be needed to detect or measure the displacement of the movable grating that represents a physical quantity such as acceleration for an accelerometer. For the displacement sensor, any type of displacement sensor or capacitance detector may be used. For example, a conventional parallel plate or comb drive can be employed as a displacement sensor, or a grating actuator may be used as a displacement sensor because the capacitance between the movable and station gratings can be easily measured by an electric circuit to provide the displacement or height (see FIG. 7a). An optical displacement sensor or vibration measurement sensor/system may be used to measure the displacement or motion of the movable grating.

### Microaccelerometer

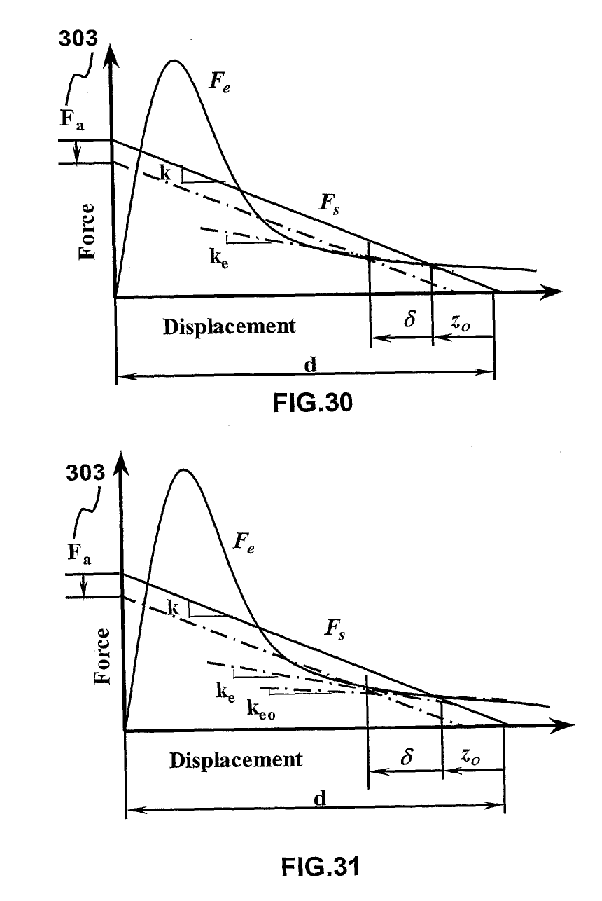

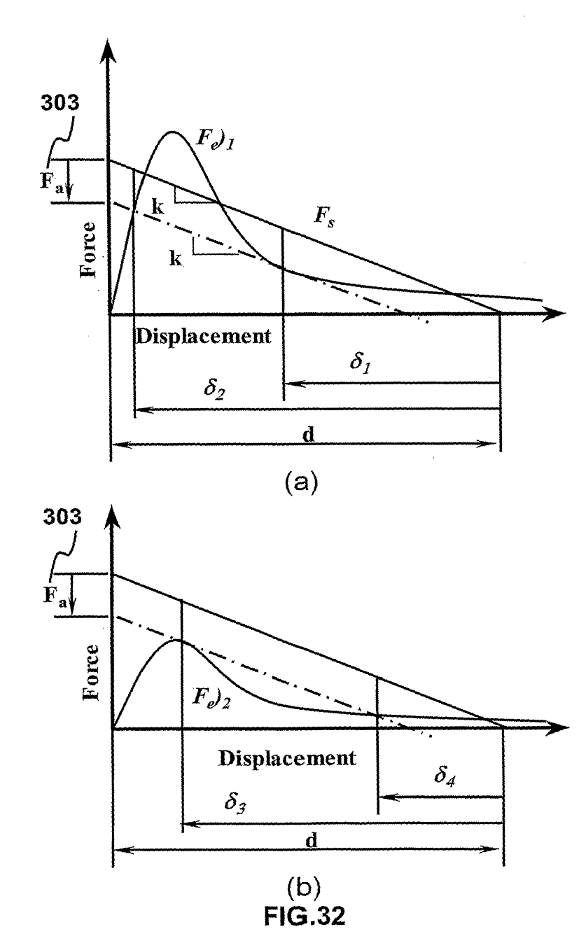

FIG. 29 shows a typical example 291 of a microaccelerometer using a grating actuator pursuant to some embodiments. In FIG. 29, the same numbers are assigned if the parts play the same roles as those in FIG. 1. The grating plate with proof mass 293 is suspended by the four flexures 6 anchored on a substrate 12 with a lower grating plate. However, if the grating plate itself 2 has sufficient mass, a proof mass may not be needed. A sensing unit 292 may be connected between the upper grating plate 2 and the lower grating 4 to detect movement of the grating plate 2 corresponding to an acceleration 294 of the actuator unit 291 in the z direction, as depicted in FIG. 29. Several types of sensing unit can be employed. For example, capacitance detection or optical detection may be used for the sensing unit 292. This microaccelerometer 291 may work in any of three modes: displacement mode (FIG. 30), resonance mode (FIG. 31), and voltage scanning mode (FIG. 32). In FIGS. 30-32 Fₐ denotes the inertial force 303 defined as mass (m) multiplied by the applied acceleration (a). In FIG. 30, a bias voltage is applied between the grating plate 2 and the lower grating 4, which causes the grating plate to move to a balance point zₒ. When an acceleration a 294 is applied to the microaccelerometer in the z1 direction (FIG. 29), the grating plate moves to the new balance position (z₀+δ). The displacement δ corresponding to acceleration a can be obtained from the force balance equation (Fa=ma=k_{eff}δ) as follows:

$$δ = \frac{ma}{{k}_{eff}} \qquad Eq . 9$$

where

k_{eff}=k−kₑ Eq. 10

is the effective stiffness, defined as the slope difference (i.e. the slope of the spring force minus the slope of the electrostatic force). The sensing unit 292 in FIG. 29 detects the displacement δ corresponding to the applied acceleration a. In FIGS. 29 and 30, any feedback controller (not shown in FIG. 29) may be used that maintains the initial displacement zₒ by applying feedback force (or voltage). In this case, the acceleration from the applied feedback force or voltage may be calculated to keep the initial position zₒ (i.e. δ=0).

FIG. 31 shows the working principle of the microaccelerometer of FIG. 29 operating in the resonance mode. When the acceleration a is applied to the accelerometer, the balance position shifts from zₒ to zₒ+δ and the electric stiffness is then shifted from kₑₒ to kₑ. Therefore, the resonance frequency of the accelerometer (defined as the square root of ((k−ke)/mass)/(2π)) is shifted from initial resonant frequency to the resonant frequency corresponding to the acceleration a. The sensing unit 292 of FIG. 29 detects the resonant frequency difference that is related to the applied acceleration and from which the acceleration can be determined.

FIG. 32 shows the voltage scanning mode of the microaccelerometer of FIG. 29. When acceleration a is applied to the microaccelerometer, the apparent spring force is shifted from the solid line to the dashed line as shown in FIG. 32(a). When the applied voltage is scanned, the grating plate is pulled in at the voltage V1 corresponding to the force curve Fe)1 of the FIG. 32(a) and pulled out at the voltage V2 for Fe)2 of the FIG. 32(b). The grating plate jumps from δ₁ to δ₂ in FIG. 32(a) while the grating plate jumps from δ₃ to δ₄ in FIG. 32b. These changes in the displacement of the grating plate are detected by the sensing unit 292 of FIG. 29 and can be converted to a electrical signal corresponding to the applied acceleration.

For another example, an acceleration switch in which the voltage is fixed at V1 corresponding to Fₑ)1 is considered in FIG. 32(a). When the acceleration is larger than the maximum acceleration corresponding to δ₁ in FIG. 32(a), the displacement change from δ₁ to δ₂ and the sensing unit detects this change in displacement. The applied voltage can be reduced to zero voltage or to a voltage less than V2 as shown in FIG. 32(b) to return the upper grating to its original position if desired.

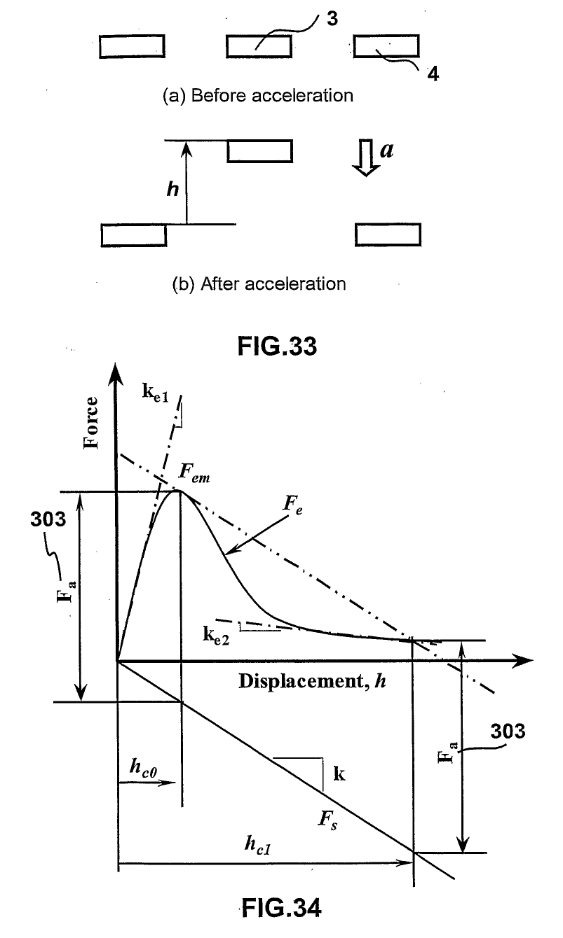

FIG. 33 shows another microaccelerometer (or acceleration switch) pursuant to some embodiments. A bias voltage is applied between the upper and lower gratings 3 and 4 to generate an attractive force, as depicted in FIG. 33(a). When an acceleration a sufficient to overcome the attraction force is applied to the microaccelerometer, the upper grating 3 moves outwards as shown in FIG. 33(b).

FIG. 34 shows the detailed dynamics of the microaccelerometer of FIG. 33. When the acceleration is applied, the acceleration (inertial) force Fa 303 equals to the sum of the spring force Fₛ and the electrostatic force Fₑ. When the acceleration force reaches the maximum resisting force (Fₑₘ+k h_{co}), the grating electrode jumps from h_{co} to a new position given as h_{c1} in FIG. 34. The movement of the grating plate is detected by the sensing units 292 (FIG. 29) to calculate the applied acceleration. To return the grating plate to its original position, the voltage can be reduced. If the bias voltage is set to the value corresponding to a predetermined acceleration a (e.g. a maximum acceleration of a vehicular air bag), the microaccelerometer of FIG. 33 can measure the predetermined (maximum) acceleration from the displacement measurement. Since the bias voltage is easily set at different voltages, the microaccelerometer (FIG. 33) acts as a tunable acceleration switch whose maximum acceleration can be adjusted. As shown in FIGS. 31 and 32, the microaccelerometer of FIG. 33 can also operate in the resonance mode, voltage scanning mode or other measurement scheme to detect the applied acceleration.

### Microgyroscope

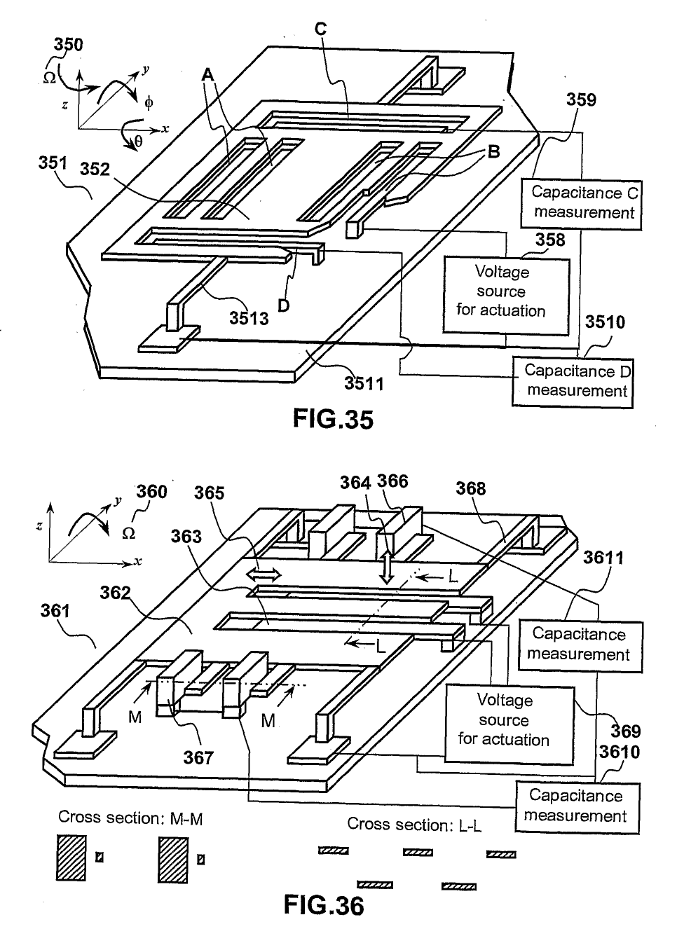

Grating actuators pursuant to some embodiments can be used to make a microgyroscope that detects and measures angular rate of rotation. FIG. 35 is a schematic, perspective view of a typical microgyroscope pursuant to some embodiments. The microgyroscope 351 includes a microplate 352 and one or more flexures 3513 supported on a substrate 3511. Between the microplate 352 and the substrate 3511, grating actuators A and B, sensors C and D are placed. Sensors C and D detect angular displacement by using capacitance of the grating actuators described in FIG. 5(a). For detection of angle or displacement, other sensors such as optical angle and displacement sensors can be used.

A typical mode of operation is as follows:

The microplate 352 is caused to vibrate at an angular frequency ω in the φ direction (350) when an alternating actuation voltage at angular frequency ω is applied to the grating actuators A and B. The angular displacement φ of the microplate is given by Eq. 11.

φ=φₒ sin ωt Eq. (11)

in which φₒ, ω and t are the amplitude of the angular displacement, the angular frequency and time, respectively.

When the vibrating microplate 352 is exposed to an angular rotation rate Ω, 350 (that is, the actuator of FIG. 35 is rotated), a moment M due to the gyroscopic effect is generated in the θ direction as given by Eq. 12.

$$M = I Ω ω = I Ω \frac{d φ}{d t} = I Ω ω {φ}_{o} cos ω t \qquad Eq . 12$$

in which I is the moment of inertia of the microplate 352.

Due to the moment M, the microplate vibrates in the θ direction and the sensors C and D measures the angular displacement as follows: Signal from the gyroscope=Sensor C signal−Sensor D signal signal=2αIΩωφ₀ cos(ωt−β), where α is a proportionality constant and β is a phase delay. The sensing signal is doubled because one sensing signal is subtracted from the other out of phase. This output signal is passed through a low-pass filter to obtain the angular rotation Ω. In FIG. 35, numbers 358, 359 and 3510 denote the voltage source for actuation and capacitance measurement means for sensors C and D.

A variation of the device depicted in FIG. 35 can be used to detect and measure an angular rate of rotation. FIG. 36 shows a schematic, perspective view of a typical linear gyroscope 361 with movable microplate 362 able to vibrate in the z direction. When the vibrating microplate is exposed to an angular rate of rotation Ω (360) about the y-axis the microplate vibrates in the x direction due to Coriolis force. The sensors 366 and 367, designed to detect only the displacement 365 in the x direction (by virtue of the displacement of the extensions that form part of the movable microplate), can be used for actuating the microplate in the x direction while the microplate is actuated by the voltage applied across the microplate 362 and the lower grating 363. The capacitance measurement means 3611 and 3610 are used to sense the displacement due to Coriolis force. If the microplate vibrates with a velocity (364), γ=γ₀ sin(ωt), a Coriolis force F_{c} is generated in the x direction and is expressed as F_{c}=2mΩγ=2mΩγ₀ sin(ωt) where m is the mass of the microplate 362. This force actuates the microplate in the x direction and the displacement is measured by the sensors 3611 and 3610. In FIG. 36, the numbers 368 and 369 are the flexure and voltage source to actuator the micro-plate 362.

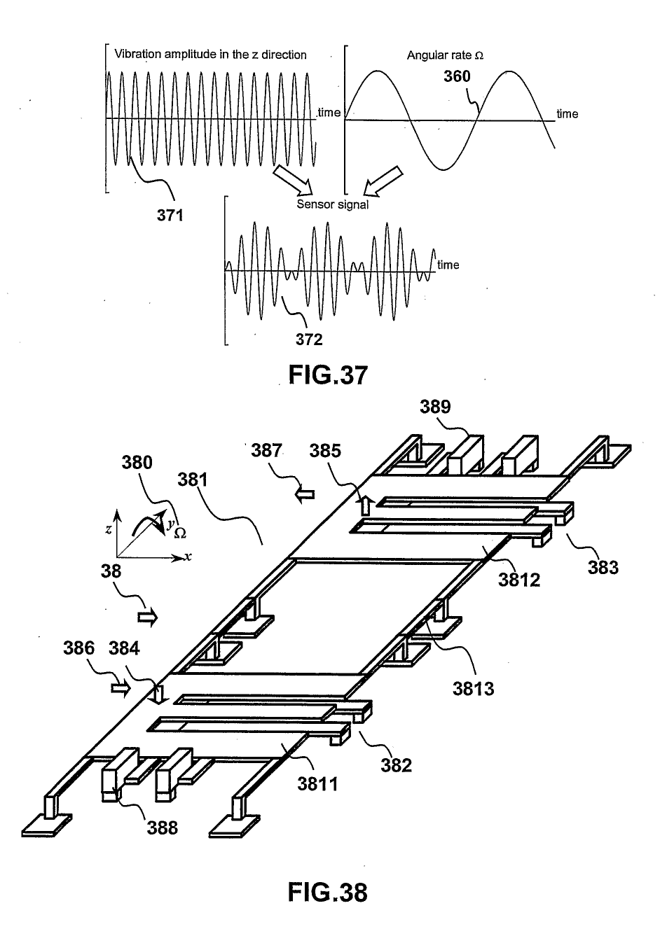

FIG. 37 shows the working principle of the linear vibrating gyroscope depicted in FIG. 36. The sensor signal 372 obtained from a summation of the measured capacitance signals is a modulated signal defined by multiplying the vibrational amplitude 371 by the angular rotation rate 360. In order to obtain the angular rotation rate 360 from the sensor signal 372, an envelope detector or low pass filter can be used.

The linear gyroscope as described herein is sensitive to an acceleration or shock in the x direction. In order to make a gyroscope insensitive to unwanted acceleration, a modified gyroscope 381 with two masses vibrating out of phase by 180° can be made as shown in FIG. 38. The microplates 3811 and 3812 suspended from flexures are connected by two coupling beams 3813 for coupling the two gyroscopes 382 and 383. The microplates 3811 and 3812 with the same mass vibrate out of phase (384 and 385) at a frequency to cancel the effect of acceleration 38 in the x direction. The opposing Coriolis forces 386 and 387 indicated in FIG. 38 are generated on the mass due to the angular rotation rate Ω (380). Sensors 388 and 389 measure these Coriolis forces 386 and 387 and the angular rate of rotation may be obtained from the addition between these sensing signals (i.e. one sensing signal plus the other). If an acceleration 38 is applied to the gyroscope, the same displacement (not shown in FIG. 38) of mass is generated and the effect of the acceleration on the sensor signal is cancelled out during the addition of the sensor signals. By placing two gyroscopes of the general type depicted in FIG. 36 or FIG. 38 in two orthogonal direction (e.g. the x and y directions) the angular rotation rate in the x and y directions can be measured. If the z direction gyroscope (FIG. 35) and the x and y direction gyroscope mentioned previously are placed on a substrate to form a general type of gyroscope, the gyroscope can measure angular rotation rate in the x, y, and z directions.

### Micromirror

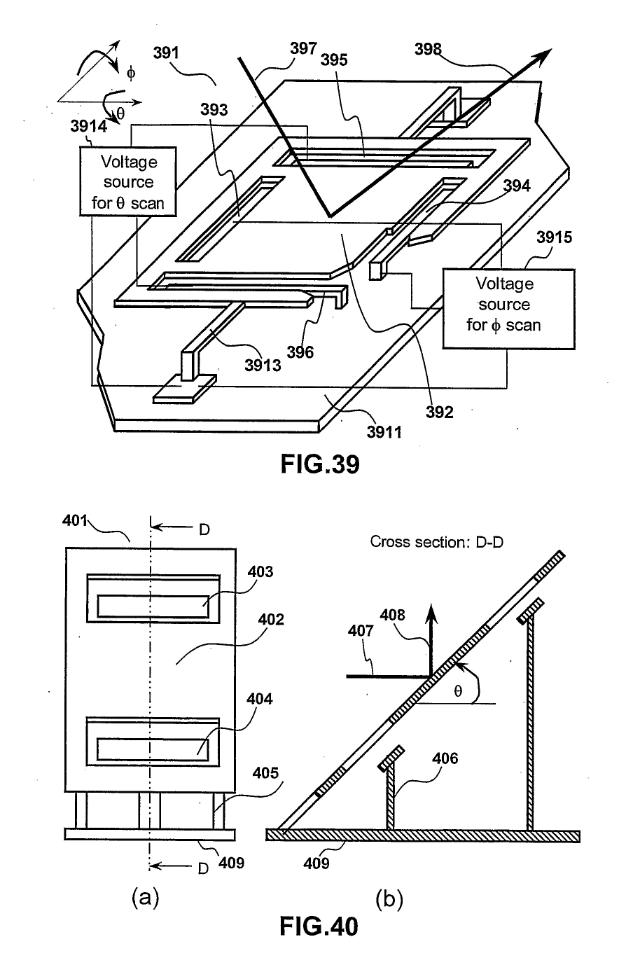

FIG. 39 depicts a typical micromirror employing a microactuator pursuant to some embodiments. A micromirror 391 consists of a reflective surface 392 mounted on a substrate 3911 by means of flexure 3913. However, two sets of grating actuators are included. Actuators 393 and 394 perform scanning in the φ direction. Actuators 395 and 396 perform scanning in the θ direction. Essentially, application of voltage (from voltage sources 3914 and 3915) causes the actuator grating to deflect by an amount related to the electrostatic force generated and the moment of inertia of the deflecting plate. The amount of this deflection can be determined by routine testing of a particular actuator and/or numerically simulated in analogy with the derivation of FIG. 5b. Application of time-varying voltages in two non-collinear directions (typically, but not essentially, two perpendicular directions) can be used to generate any desired scanning of the reflective surface. Thus, actuating the micromirror in the φ direction and in the θ direction, the incident light 397 is scanned in the desired manner. For better scanning performance, a control scheme and sensors for detection of the reflected light 398 and/or the angular motion may be used and applied, typically in a feedback manner, to adjust the motion of the micromirror more accurately.

The micromirrors discussed herein with the specific example of reflecting light, typically visible light as might be useful in visual displays. However, the micromirrors pursuant to some embodiments are not inherently limited to visible light but can be used for directional control of any wavelength of electromagnetic radiation (or indeed, any wave or particle) for which a suitable reflective surface 392 can be obtained and used.

FIG. 40 shows other mirror structures pursuant to some embodiments in schematic, perspective view (FIG. 40a), and cross sectional view (FIG. 40b). In this configuration, an inclined micromirror 402 is supported by flexures 405 on a substrate 409. Grating actuators 404 and 403, consisting of slits and gratings, are used to generate an angular motion. When voltage is applied to the actuators 403 and 404, the mirror 402 scans the incident light 407 in the θ direction of FIG. 40. The number 408 denotes the reflected light and 406 is support for grating.

### Grating Light Valve

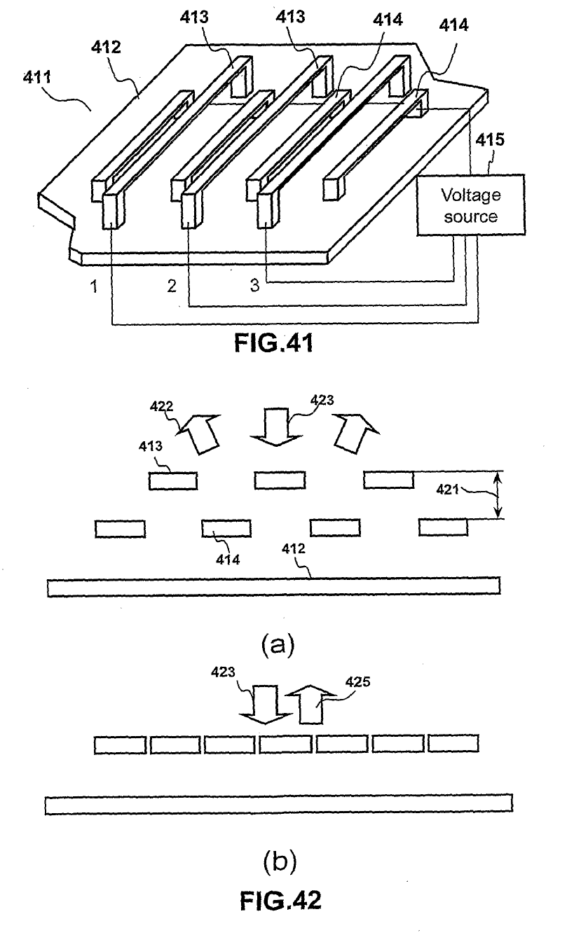

Reflection and transmission grating light valves can also be fabricated making use of actuators pursuant to some embodiments. FIG. 41 shows a schematic, perspective view of a portion of a typical reflection grating light valve 411. The grating light valve 411 consists of an array of the grating actuators having reflective surfaces 413 (for the incident wave of interest) of the upper and lower gratings and mounted on a substrate 412 that have reflective surfaces. An applied voltage from a voltage source 415 is used to control the movement of each actuator 1, 2 or 3. The stiffness or flexibility of the upper and lower gratings 413 and 414 is designed so as to have a predetermined value, depending on applications, since the stiffness is a function of the Young's modulus, the height, length, and width of the gratings. For example, if the length of the upper grating is made to be larger than that of the lower grating so that upper grating is more flexible than lower grating. FIG. 42 shows a typical method of operating the grating light valve of FIG. 41. With no voltage applied, the incident light 423 is reflected on the surface of both upper and lower gratings and experiences diffraction as the reflected beams interact upon leaving the gratings. The characteristics of this diffracted light 422 is a function of the initial gap 421 in FIG. 42(a) and the pitch of the gratings. Virtually any initial gap 421 can be used depending on the incident wavelength of interest and the desired performance, but the following initial gap is found to be advantageous to diffract the incident light.

$$g = ( \frac{1}{4} + \frac{n}{2} ) λ \qquad Eq . 13$$

where g is the initial gap (as depicted in FIG. 42a), n=0, 1, 2 . . . and λ is the wavelength of the incident light. Eq. 13 is a condition to make diffraction. For example, for g=λ/4, and no applied voltage, the grating light valve diffracts the incident light. Applying a voltage larger than the pull-in voltage between the upper and lower gratings 413 and 414 causes the upper grating to pull-in to the lower grating substantially in the position shown in FIG. 42b. In this configuration, all gratings reflect the incident light 424 and the reflected light 425 is sent to the light source (not shown in the figure). As a result, the grating actuator may be used to make reflected or a diffracted pattern of the incident light by controlling the voltage between the gratings.

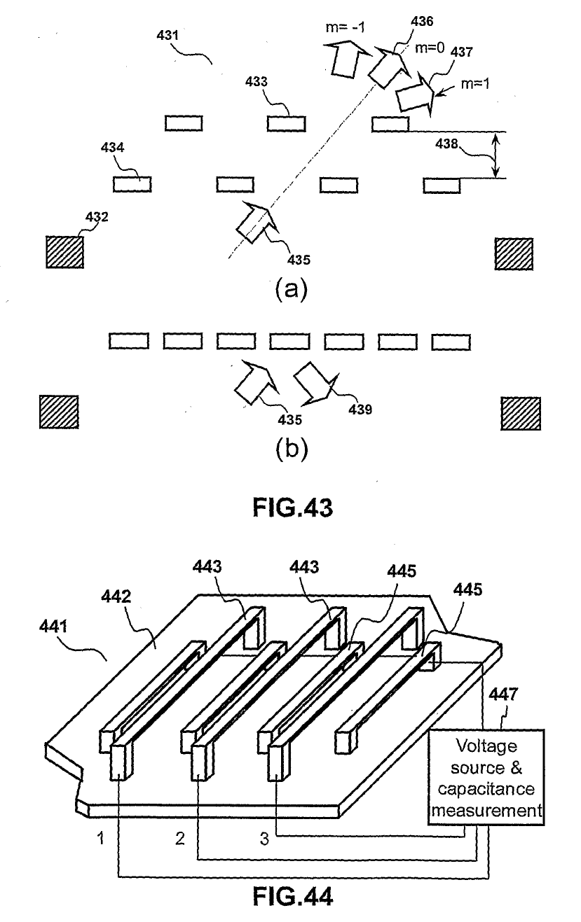

FIG. 43 shows a different type grating light valve employing actuators pursuant to some embodiments, in particular, a transmission grating light valve. The light valve 431 can be made by removing some portion of the substrate 432 of the reflection grating light valve shown in FIG. 41 such that incident light 435 has an unobstructed path through the substrate and can be directed onto the grating light valve from the direction of the lower gratings. With no voltage applied between the upper and lower gratings 433 and 434, the incident light 435 passes through space formed between the upper and lower gratings 433 and 434 emerging therefrom in a diffraction pattern having various diffraction orders m in FIG. 43a. Upon application of an appropriate voltage between the upper and lower grating, the gratings move to the positions depicted in FIG. 43b, thereby blocking the incident light 435. The reflected light 439 is sent downward.

The grating light valves are described herein as having substantially identical voltages applied at substantially the same time so that all gratings move substantially in unison. It is believed that this is likely to be the most practically useful method of operation of the grating light valve, but is not an inherent limitation. Conventional circuitry can be used to apply different voltages to different gratings, and/or apply the same or different voltages to different gratings as different times. This provides considerable flexibility for the optical engineer in controlling the spatial and temporal properties of the grating light valve. It is envisioned that these light valves can be used for a variety of optical applications, such as displays, light modulators, among others.

### Tunable Capacitor

Capacitors are essential component in virtually all electronic devices. In many such devices, one or more tunable capacitors are often used to adjust resonant frequency and other performance characteristics of the electronic device by adjusting the capacitance. Conventional tunable capacitors using the parallel plate are often used, but typically suffer from one or more disadvantages, such as stiction, and a relatively small tuning range (often limited to a maximum 50% increase above the original capacitance).

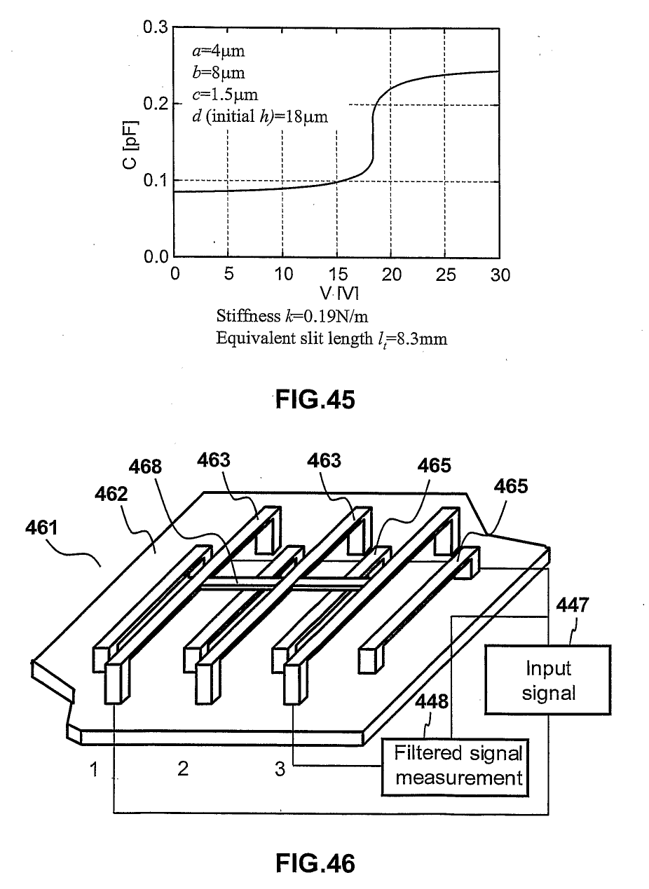

The grating actuator pursuant to some embodiments can be used for making tunable capacitors that do not experience the stiction problem (i.e. no mechanical contact) as well as provide tunability of capacitance above a broader range. FIG. 44 shows a schematic, perspective view of a typical embodiment of the tunable capacitor 441 on a substrate. The grating actuators (as described in connection with FIG. 41 above) act as tunable capacitors when a voltage controller adjusts the applied voltage between the upper and lower gratings 443 and 445. FIG. 44 illustrates the method of operation of the tunable capacitor. When voltage from a voltage source 447 is applied less than the pull-in voltage, the upper grating 443 moves downward with respect to the lower gratings 445 as shown in FIG. 42a, decreasing the vertical separation h (not shown in the figure). When the voltage is increased to the pull-in voltage, the upper grating is pulled into the lower grating as depicted in FIG. 42b (where h=0). FIG. 45 shows the behavior of the capacitance of the upper and lower grating structure of Table 1 as a function of the applied voltage. FIG. 45 shows the capacitance change of the grating structure of Table 1 when the applied voltage increases. The capacitance is suddenly changed at V=18.3V and the pull-in and pull-out occur at almost the same voltage of 18.3V. The pull-in and pull-out voltage can be reduced by using softer spring or by changing geometry (e.g. smaller a or larger lₜ).

### Mechanical Filter

FIG. 46 is a schematic, perspective view of a typical mechanical filter 461 using a grating actuator. This device has the capability of filtering an electrical signal while the mechanical structure is actuated by the input electrical signal 447. This kind of filter may be used for radio-frequency devices or systems, among other purposes.

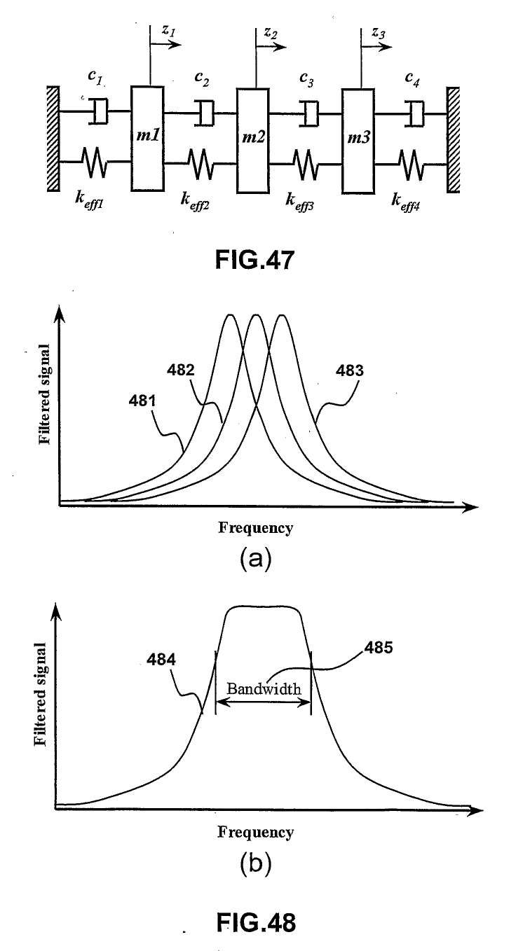

FIG. 46 depicts a plurality of grating actuators on a substrate 462 connected by flexures for coupling, while the electrical signal 447 to be filtered is applied to the lower grating 465 by means of a contact. The filtered electrical signal is picked up at the upper grating as shown in FIG. 46. The picked signal is measured by the filtered signal measurement mean 448. Upper gratings 463 can be connected by a coupling beam 468 to make a wide bandwidth of the filter. FIG. 47 is a three-degree-of-freedom equivalent model of the mechanical filter of FIG. 46. A series of masses, dampers, and springs are connected to filter the input signal. z, m, c, and k_{eff} stand for the displacement and mass of the upper grating, the damping coefficient and the effective stiffness reflecting the structure stiffness and the electrostatic stiffness, respectively. The subscripts 1, 2, and 3 denote the number of the gratings in FIG. 46. Using modal analysis of this equivalent model of the mechanical filter, three separate modes 481, 482 and 483 are obtained, reflecting the corresponding mechanical behavior in FIG. 48(a). The summation of these responses 481, 482 and 483 to the frequency provides the spectrum 484 (FIG. 48) of the filter of FIG. 46. The bandwidth 485 and other parameters of the filter's response can be adjusted as desired or selected by an appropriate choice for the geometry and for the number of grating actuators used. The effective stiffness in FIGS. 46 and 47 are also adjustable so that the bandwidth and other parameters of the filter can be changed by means of the applied bias voltage.

### Tuning Fork

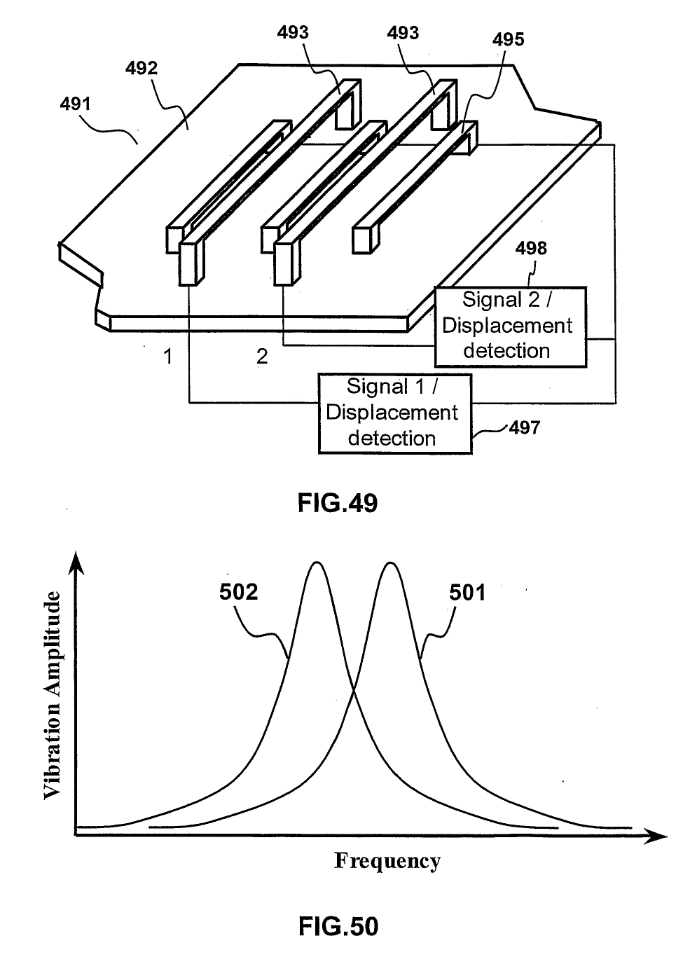

Many mechanical sensors, such as microgyroscopes among others, use tuning forks as a convenient means to actuate the microstructures. Grating actuators pursuant to some embodiments can also be used to construct a mechanical tuning fork. FIG. 49 shows a schematic, perspective view of a typical tuning fork 491 including of a pair of substantially identical grating actuators. The grating actuators (1 and 2) are consists of the upper and lower gratings 493 and 495 on a substrate 492. When the grating actuators are actuated by separate applied voltages (497 and 498) out of phase (i.e. phase difference of 180°), the two upper gratings 493 vibrate out of phase at a resonant frequency. The resonant frequency is sensitive to the effective stiffness, and the stiffness can be adjusted by altering the applied bias voltage. Therefore the resonant frequency of the tuning fork can be adjusted as shown in FIG. 50. The response curve 501 at lower bias voltage is shifted to the left curve 502 when higher bias voltage is applied. Higher bias voltage results in lower resonant frequency. This type of tuning fork can be also used as a mechanical filter of electrical signals. The numbers 497 and 498 (not explained) in FIG. 49 denote means for actuating the grating and the sensing the displacement of the grating.

### Microactuator for Atomic Force Microscopy

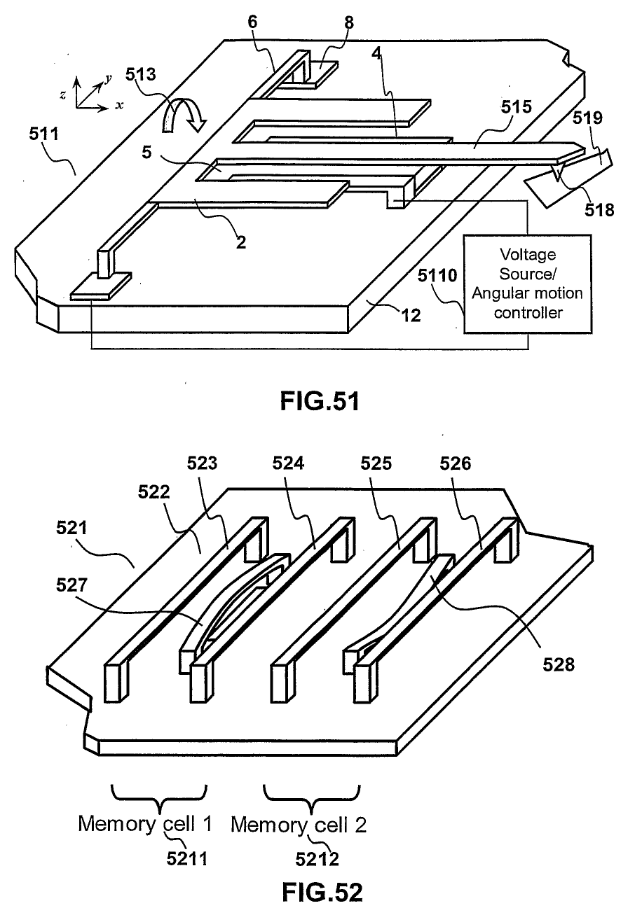

Many precision machines, such as Atomic Force Microscopes (AFMs), among others, require a precise mechanical actuator to scan images. FIG. 51 shows a schematic of a typical AFM 511 using a grating actuator shown in FIG. 27. In FIG. 51, the same numbers are assigned if the parts play the same roles as those in FIG. 27. In order to scan images, the AFM tip 518 attached to the upper grating cantilever beam 515 of the grating actuator is able to move up and down while the specimen 519 may move in directions parallel to the substrate surface. The movement of the AFM tip can be controlled by controlling the applied voltage from the voltage source/motion controller 5110.

### Mechanical Memory

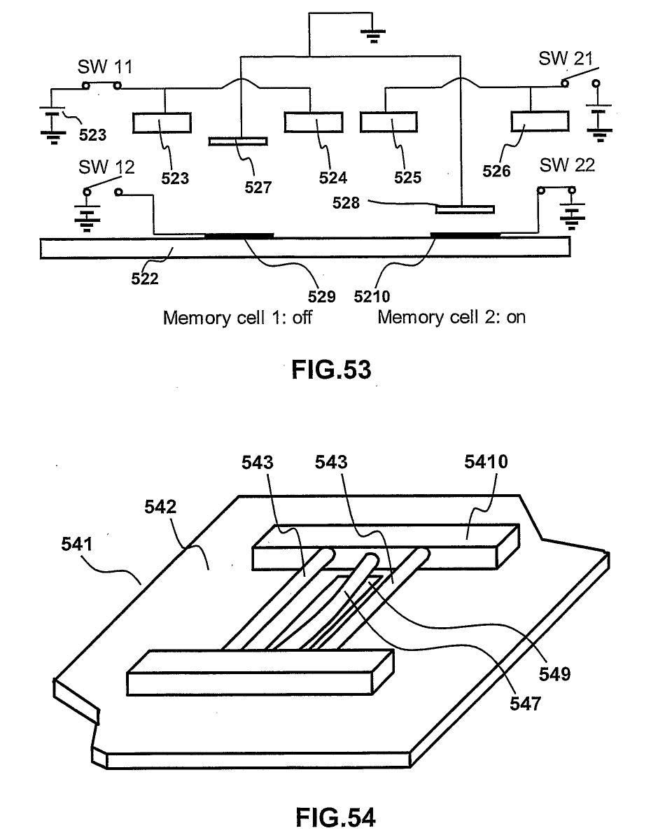

Grating actuators pursuant to some embodiments can also be used to make mechanical memories. A typical example 521 is shown schematic, perspective view in FIG. 52. In FIG. 52, the lower gratings are fixed-fixed beams that are compressed by an internal stress (not shown in the figure). The internal stress is used to cause the lower grating to be buckled and the stress can be a residual stress generated during the fabrication or an induced stress such as thermally induced stress due to thermal expansion. The lower grating 527 is buckled and bistable at two positions as shown in FIG. 52. The left and right lower gratings 527 and 528 (memory cell 1 (5211) and memory cell 2 (5212)) are shown to be convex and concave, respectively in this depiction. In either of these states, no additional application of force or energy in required in order to maintain the geometric states. In FIG. 52, the numbers 522 and 523-526 are the substrate and the upper gratings. FIG. 53 is a schematic depiction to show the working principle of the mechanical memory of FIG. 53. When the state of the memory cell needs to be changed, voltage 523 is applied to the upper grating (for concave to convex switching) or to the electrode 529 and 5210 residing on the substrate (for convex to concave switching). Memory cell 1 shows an “off” state (for example) before applying voltage and switches to its “on” state when switch SW12 is turned on and SW11 is turned off. Since the voltage is applied to each switch and the bistable lower grating 527 maintains the state into which it is placed, additional energy is not needed to keep the switch in its on or off state. One or more arrays of these mechanical memories may be used to store information. Instead of the lower electrode on the substrate in FIG. 53, a set of stationary gratings (similar to the upper grating) can be placed under the lower gratings 527. For upper and lower grating of the mechanical memory in FIG. 53, any shape of any conductors can be used. For example, an array of circular nanotube for the upper and lower grating in FIG. 53 may also be used for the mechanical memory.

FIG. 54 shows a unit memory cell 541 that uses carbon nanotubes 543 and 547. The working principle of the mechanical memory (FIG. 54) is the same as that of FIG. 53. Tensioned and buckled carbon nanotubes are hung between two supporters 5410 on a substrate 542 and an electrode 549 for pull-in is placed under the buckled carbon nanotube. the tensioned carbon nanotube 543 is used as the upper grating and buckled nanotube 544 is as the lower grating. The position of buckled carbon nanotube is controlled by applying the tensioned grating 543 or lower electrode 549 and the unit cell of FIG. 54 can be used a mechanical memory.

### Microphone, Pressure and Force Sensors

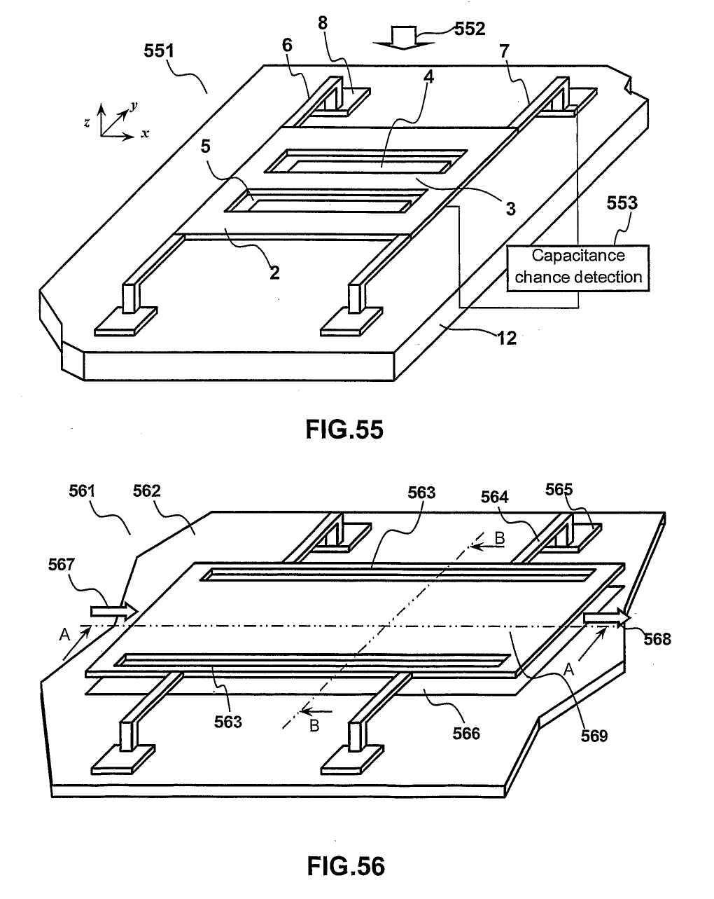

FIG. 55 is a schematic, perspective depiction of a microphone 551 using a grating actuator. In FIG. 55, the same numbers are assigned if the parts play the same roles as those in FIG. 1. When the grating plate 2 with its upper grating is exposed to an incident acoustic wave (pressure wave), the grating plate move up and down and this movement can be detected by the capacitance-change detector 553. The capacitance-change detector 553 is converted to electrical signals for further signal processing or recording. In reverse case, the microphone 551 may become an acoustic speaker when voltage with voice information is applied between the upper and lower gratings 3 and 4 (or any other information in the voltage signal for which an acoustic rendition is desired). This varying voltage causes the grating plate to vibrate, generating acoustic pressure waves (i.e. sound).

This device can also be used as a pressure and/or force sensor. If pressure or force is applied to the grating plate 2, capacitance of the device changes which can readily be detected by conventional capacitance detection circuitry or instrumentation, thereby detecting the pressure and/or force.

### Tunable Wave Guide

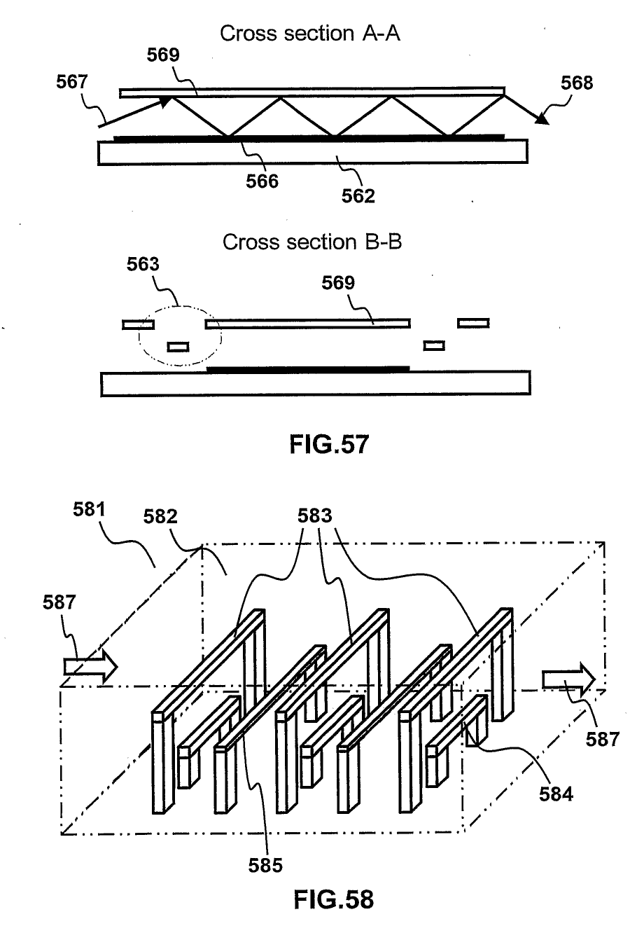

FIG. 56 show a typical example of a tunable waveguide using that a grating actuator that has the capability to filter the incident light (or some other form or electromagnetic radiation). FIG. 57 is a cross-sectional view of the tunable waveguide of FIG. 56. A typical waveguide 561 as depicted in schematic perspective view in FIG. 56, typically includes an upper mirror 569 suspended by flexures 564 and actuated by the grating actuator 563 and a lower mirror 566 fixed on the substrate 562. If the incident light 567 is white light, the wavelength of filtered light is related to the gap between the upper and lower mirrors 569 and 566. Therefore, the filtered light is controlled or modulated by the applied voltage across the actuator gratings. If an electromagnetic wave with wavelength outside the range or visible light, the wave can also be filtered in an analogous manner. The device configuration depicted in FIGS. 56 and 57, can also be used to fabricate a Fabry-Perot interferometer whose mirrors are partially transparent and whose substrate is substantially transparent at the wavelength of the incident radiation. When electromagnetic radiation is incident on the structure from the back (substrate) side at an angle with the transparent substrate, transmitted light experiences multiple reflections along the length of the device between the mirrors and make can produce a Fabry-Perot interference pattern on a distant screen.

### Fluidic Devices/Microarray

The microactuators pursuant to some embodiments can also be use in connection with microarrays and fluidic devices, for example, mixers, PCR devices, valves, among others.

### Fluidic Mixer

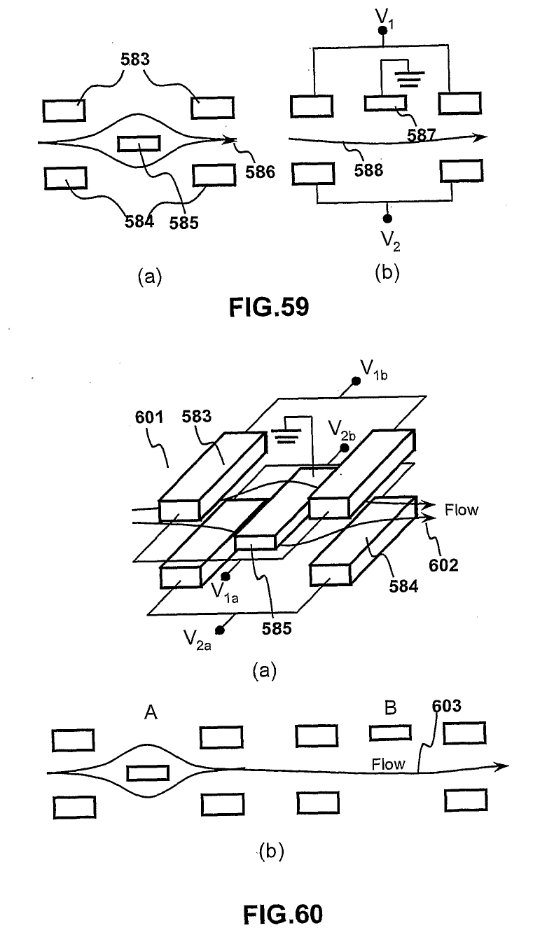

In microfluidic systems, fluidic micromixers play an important role because they can mix chemicals (or reagents) with fluid. Using the grating actuator pursuant to some embodiments, an effective mixer may be made, a typical example of which is shown in FIG. 58. The mixer 581 of FIG. 58 consists of a set of movable gratings 585 and stationary gratings 583 and 584 (upper and lower) in a fluidic channel 582. Fluid 587 flows in from the left hand side and flows out to the right hand side. It is noted from FIG. 58 that upper stationary grating 583 as well as lower stationary grating 584 are used to overcome the fluidic resistance (in other words, to increase the electrostatic force on the movable grating). FIG. 59 depicts the working principle of the fluidic mixer of FIG. 58. Before applying a voltage on the movable grating 585 (FIG. 59a), the movable grating 585 remains at the center (initial position). When a voltage V1 is applied across the movable and upper-stationary gratings as shown in FIG. 59b, the movable grating 587 moves upward and remains at up-position. If V1 become zero and V2 is applied across the movable and lower-stationary grating, the movable grating will move down. Therefore, the position of the movable grating is controlled by applying the voltages to the upper and lower stationary gratings and the stream of the fluid flow is adjusted as shown in FIGS. 59a and 59b. In FIG. 59a, the stream can be divided into two sub-streams and combined into one 586. In FIG. 59b, the stream is not divided but keeps the original stream 588. Splitting and combining streams allows chemicals in the fluid to easily mix with the fluid. The position and vibration frequency of the movable grating may be adjusted to make better mixing.

### Polymerase Chain Reaction (PCR)

PCR is one of most important processes in biochemistry to amplify specific portions of DNA. PCR includes a series of heating and cooling process (e.g. 94° C. for denaturation, 54° C. for annealing and 72° C. for DNA extension). Almost the same grating actuator as shown in FIG. 58 may be used for the heating and cooling process for PCR. FIG. 60 shows the working principle of PCR (601) making use of some embodiments. For convenience of explanation only the movable and stationary grating are shown in FIG. 60. A set of movable gratings (585), upper- and lower-stationary gratings (583 and 584) is placed in a fluidic channel (not shown in FIG. 60). If needed, many sets of the gratings may be placed along the channel depending on applications. Voltages may be applied to the movable grating and the upper and lower stationary gratings to heat and cool the gratings or to actuate the movable grating up and down. FIG. 60a shows an example of an electrical connection for PCR 601. In FIG. 60a, the movable grating 585 is grounded, the voltages V1a and V1b are applied across the upper stationary gratings 583 for heating and for controlling the position of the movable grating while V2a and V2b are applied across the lower stationary gratings 584 for heating and for adjusting the position of the movable grating 585. For convenience of explanation, V2a and V2b can be set as zero. In this case, the voltage difference V1b−V1a is used to heat the upper-stationary grating 583 and to adjust the position of the movable grating 585. If V1a and V1b are set as zero, the voltage difference V2a−V2b plays a role for heating the lower stationary grating 584 and for controlling the movable grating 585. Any combination of the voltages applied to the gratings is used to heat the gratings in the channel and to control the position of the movable grating while fluid (602) flows. FIG. 60b shows the two cases along the channel. Case A shows that all voltages are zero and then the movable grating is at the middle position. Case B depicts that the voltage on the upper stationary gratings are activated to heat the upper stationary grating and to move the movable grating to the upper position. Therefore, the stream 603 is split and combined while the fluid is cooled and heated. This action including heating and mixing makes PCR based on the embodiment disclosed more efficient (i.e. better amplification of DNA) because the present PCR can amplify DNA during mixing as shown in FIG. 60b.

### Fluidic Valve

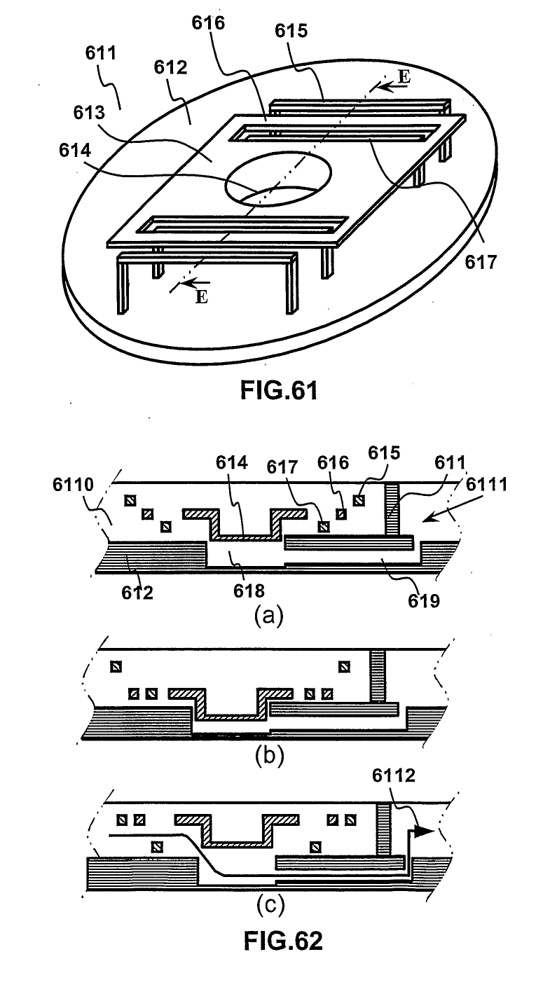

The grating actuators pursuant to some embodiments in cooperation with a piston plate (or any means to displace volume, e.g. plate) can be used in the form of a fluid valve that can be used in a fluidic device. FIG. 61 shows a perspective view of a typical fluidic valve 611 employing some embodiments. For explanation convenience, only basic components of the valve on a substrate 612 are shown and the channel and other parts are shown in FIG. 62. A typical valve 611 consists of a movable piston connected to a piston plate 613, movable gratings 616 connected to the piston plate 613, flexures to suspend the movable grating (not shown in FIG. 61), and upper and lower gratings 615 and 617. FIG. 62 shows the working principle of the fluidic valve (crosses-sectional view of E-E of FIG. 61). FIG. 62a shows the middle position of the valve in a fluid channel. Under the piston 614, there is a chamber 618 which may be connected to other fluidic channels 6111 via fluid path (619). The channels are separated by separation wall 611 and the left channel 6110 is pressurized by a pressure generation means such as micropump or syringe (not shown in the figure). FIGS. 62b and 62c show closed and open status of the valve, respectively. With pressure in the channel, the valve may be closed initially as shown in FIG. 62b. If the stiffness of the flexures can resist the pressure in the left channel 6110, a voltage may be applied across the movable and lower gratings 616 and 617 to close the valve (FIG. 62b). When a voltage is applied across the movable and upper gratings 616 and 615, the valve is opened to make the flow path 6112 (FIG. 62c). Because the piston 614 is controlled by the voltages between gratings, the valve can be closed or open.

### Pump

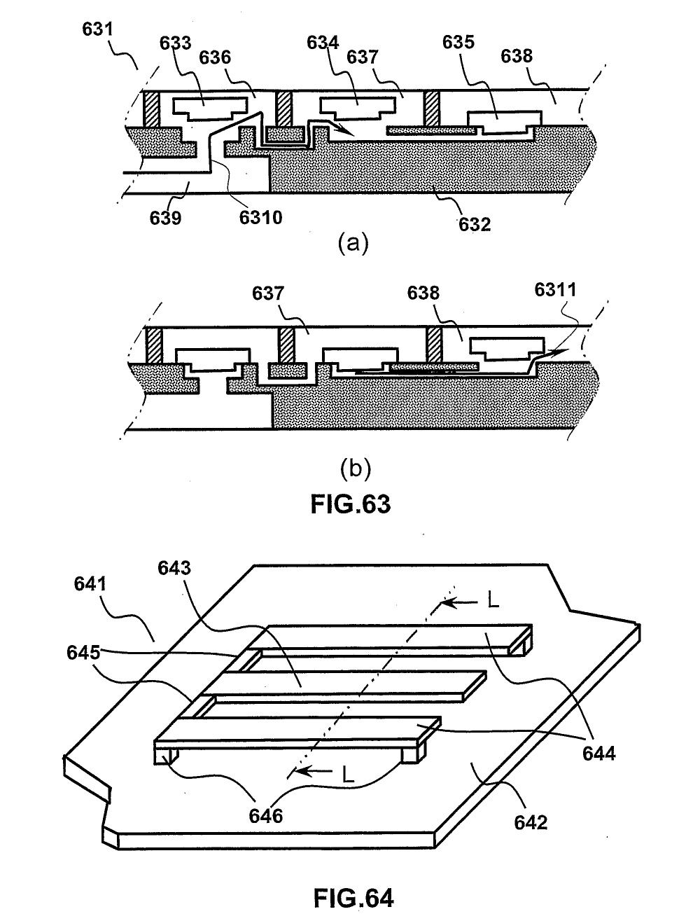

Using the above valve (FIG. 61), one can build a mechanical pump that is operated by the applied voltage. FIG. 63 shows the cross section of the mechanical pump 631 that consists of three valves sifting a substrate 632, and two channels 639 and 638. For convenience, only pistons of the valves (FIG. 62) is shown in FIG. 63. The valve 633, 634 and 635 are placed between the left channel 639 and room 636, the middle room 637, and room in channel 638, respectively. As shown in FIG. 63a, the fluid (6310) in the left channel 639 is transported to room 637 while the pistons 633 and 634 move up and the piston 635 keeps down. In FIG. 63b, the fluid (6311) in the room 637 is displaced to the right channel 638 when the pistons 633 and 634 move down and piston 635 is up. Therefore, the pump is operated to transport fluid from the left channel 639 to the right channel 638 or to make pressure difference between the channels 639 and 638. The right and left valves can be replaced with any conventional active and passive valves depending on applications.

### Microarray

Microarrays (in particular, DNA or other oligonucleotide chips) is a combinatorial array in which microscopic spots of single stranded DNA (or other hybridizable species) are attached in the form of chemically suitable matrices on a substrate. In conventional microarrays, probes (oligonucleotides, cDNA, or small fragments) on small sites are hybridized with targets that can be designed for the probes. The target can be labeled by using a radioactive or fluorescent tag and the hybridized DNA can then be detected or read by using fluorescence detection technology that usually uses a expensive laser scanning system. Using the repulsive force actuator (as shown in FIG. 21), a DNA microarray can be produced in which the conventional light from a conventional, inexpensive light bulb or laser can be used for the DNA detection system.

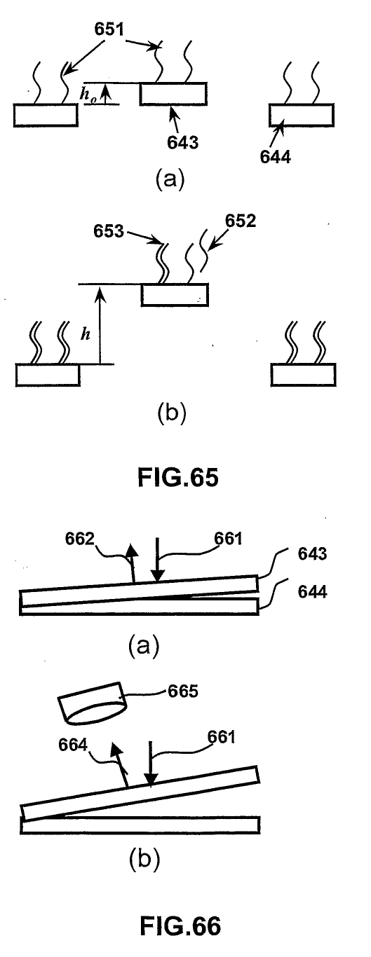

FIG. 64 shows a typical DNA microarray 641 pursuant to some embodiments. The movable grating 643 is connected via flexures 645 to the stationary gratings 644 that are anchored on a substrate 642. The number 646 is the anchor. Both the movable and stationary gratings 644 and 645 are covered with probes such as oligonucleotides that can be hybridized when the probe is exposed to the target. FIG. 65 is the cross-sectional view of FIG. 64 along line L-L and shows the working principle of the microarray. In FIG. 65a, both movable and stationary gratings are covered with DNA probes 651. Due to initial negative charges (not shown in the figure) of the DNA probe 651, the movable grating 643 is spaced by an initial height hₒ from the stationary grating 644. In order to obtain a suitable initial height, the movable grating may be initially spaced apart from the stationary grating during fabrication of the microarray. When the DNA probes on the movable and stationary gratings are exposed to a fluid with DNA targets (FIG. 65b), the DNA probes are hybridized with the DNA targets 652 and the increased repulsive force of the hybridized DNA 653 pushes the movable grating from hₒ to h. The displacement of the movable grating can be detected by any displacement detection means. For example, optical detection systems can be used for measurement of the angular or linear displacement or an electrical circuit embedded in the substrate may be used to measure the capacitance change due to the displacement and/or increased negative charge due to DNA hybridization. As an example, an optical system using CCD (Charge-Coupled Device) and white light from a light bulb can be used to detect the DNA hybridization as shown in FIG. 66. The incident light of both FIGS. 66a and 66b is reflected by the movable and stationary gratings 643 and 644. The light angle 664 made by the movable grating with hybridized DNA (FIG. 66b) is larger than that with nonhybridized DNA (FIG. 66a). Therefore the hybridized DNA can be detected by an angle measurement system 665 such as CCD camera or microscope.

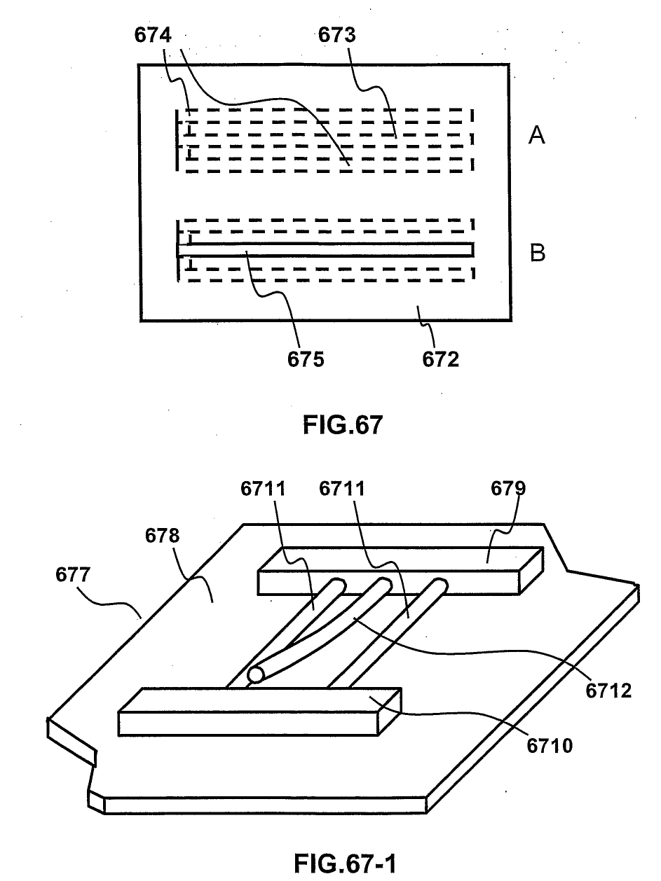

FIG. 67 shows a typical type of image as would be detected by the measurement system. In FIG. 67, A and B represent the movable gratings with nonhybridized and hybridized DNA, respectively. Additionally deflected movable grating 675 with hybridized DNA is clearly shown while the other gratings 643 and 674 (stationary gratings and movable grating with nonhybridized DNA) on the substrate 672 are not clearly shown. Appropriate software on a computer may be used to detect and/or to process information on DNA hybridization.

The DNA microarray using the same principle can be fabricated by using nanostructures. For example, FIG. 67-1 shows the smaller DNA microarray 677 of that shown in FIG. 64. The microarray 677 consists of two nanotubes 6711 (suspended between the support 679 anchored on a substrate 678) and one nanotube 6712 whose one end is fixed on a support 679. The cantilvered nanotube 6712 is spaced by a predetermined distance apart from the fixed-fixed nanotube 6711. The nanotubes are be covered with DNA probes as shown in FIG. 65. If needed, insulator may be formed between the DNA probes the nanotubes. The hybridized DNA generates repulsive force, so that the cantilevered nanotube 6712 is displaced from an initial position. This displacement can be detected by any displacement detection means such as optical detector.

### Grating Actuator for Multi-Motions

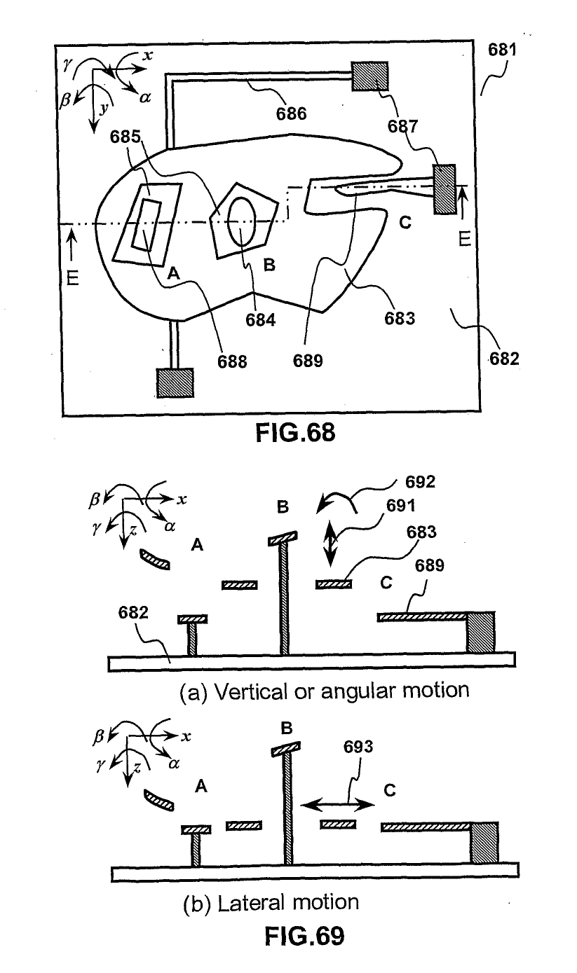

The descriptions herein relate chiefly to the computer simulation and fabrication of the microactuator having substantially the structure depicted in FIG. 1 and Table 1. However, the descriptions, teachings and working concepts presented herein can be used for other forms of microactuators as well as extensions to nano-actuators and sensors. More generalized structures consisting of movable and anchored structures can be considered, a generic example of which is shown in FIG. 68. Depending on specific applications or purposes, actuators 681 using slits 685 having different shapes can be employed, for example, A, B, and C in FIG. 68. The actuators 681 may be on a substrate 682 in any shape depending on designs or applications. FIGS. 69a and 69b depict cross-sectional views along line E-E in FIG. 68 to help illustrate the working principle for multi-mode actuator motions. The configurations may be changed for specific applications. For example, a light modulator or micromirror, could include an array of one or more of the actuators (A, B, or C) along the perimeter of the movable structure 683. Flexures 686, attached by anchors 687 on the substrate 682, can be designed to support the movable structure 683 or to impose constraints on the movable structure. For easy explanation, the actuator C is used in FIGS. 68, 69a and 69b. When a voltage (not shown in the figure) is applied across the movable and anchored structures (683, 684, 688, and 689), an electric field is generated between the movable and anchored structures, so that electrostatic forces acting on the movable structure 683 in the x, y, and z directions appear. These electrostatic forces also generate moments acting on the movable structures 683 in the α, β, and γ angular directions. As a result of the electrostatic forces and moments acting on the movable structure, the movable structures can move in the x, y, or z directions or in the α, β, or γ angular directions, depending on the constraints imposed by the flexures 686. When AC drive voltage with a DC bias voltage less than the pull-in voltage is applied, the movable structure 683 can vibrate in multi-directions such as the z and β-directions (691 and 692) as shown in FIG. 69a. If the RMS (root-mean-square) voltage of the AC drive and DC voltages reaches a certain voltage such as the pull-in voltage, the movable structure may pull down and vibrate in the x direction (693) in FIG. 69b or in multi-directions (a combination of vibration mode in FIGS. 69a and 69b, depending on constraints. The actuators, A and B, can also generate vibrations due to electrostatic forces and moments in multi-directions. Configurations of actuators 681 and flexures 686 allow the movable structure 683 to move in the desired directions and to constrain the movable structure 683 in unwanted directions. As such, an electrostatic microactuator using slit structures can be used for micro- or nano-systems that require large force or large travel range.

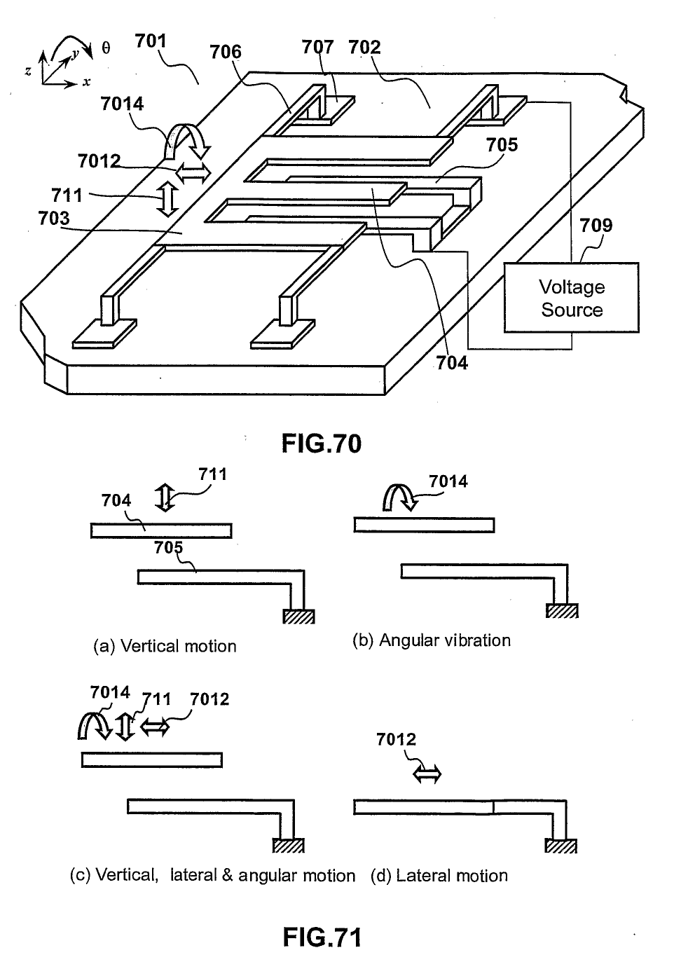

FIG. 70 shows a grating actuator 701 for multi-directional motions, a specific example of general configuration of the grating actuator of FIG. 68. The grating plate can move or vibrate in the x- and/or z-directions and rotate in the θ direction. One possible vibration modes are shown in FIG. 71. The vibration 711, 7012 and 7014 may be selected by design of the flexures 706 suspended from the anchors 707 on the substrate 702, the upper and lower gratings 704 and 705, and a proper choice for the applied voltage from a voltage source 709. The capacitance C formed between the upper and lower gratings is given by Eq. 14.

C=function (geometry)=ƒ(x,z,θ,other geometry) Eq. 14

The electric energy U stored in the capacitance is

$$U = \frac{1}{2} {CV}^{2} = f ( x , z , θ , other geometry ) {V}^{2} . \qquad Eq . 15$$

The forces in the x- and z-directions and moment in the θ-direction is given by Eqs. 16-18.

$$\begin{matrix}{F}_{x} = - \frac{\partial U}{\partial x} & Eq . 16 \\ {F}_{z} = - \frac{\partial U}{\partial z} & Eq . 17 \\ M = - \frac{\partial U}{\partial θ} . & Eq . 18\end{matrix}$$

F_{z} and M can be sufficient for the upper plate to experience the pull-in and pull-out phenomena as already mentioned. Any combination of these forces and motion, the grating actuator can move in the possible modes shown in FIG. 71. The actuator can vibrate in one mode (FIGS. 71 a, b, and d) or mixed mode (FIG. 71 c).

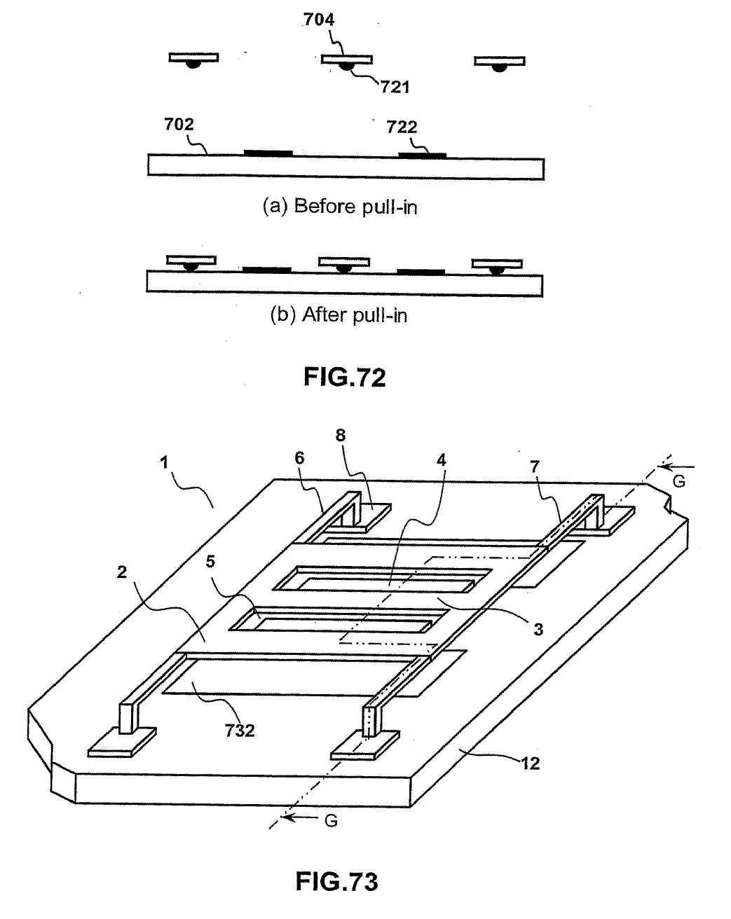

FIG. 72 shows cross-sectional view of a different type of grating actuator whose lower grating 722 sits on the substrate. It is an actuator modified from FIG. 1. Although the lower grating 722 is on the substrate 702, its working principle is the same. With this embodiment the actuator may be easily fabricated because the lower structure 722 and the electrical connections are formed by using the same mask for mask photography. The movable grating 704 may have bumps 721 to avoid stiction when it experiences the pull-in.

### Fabrication

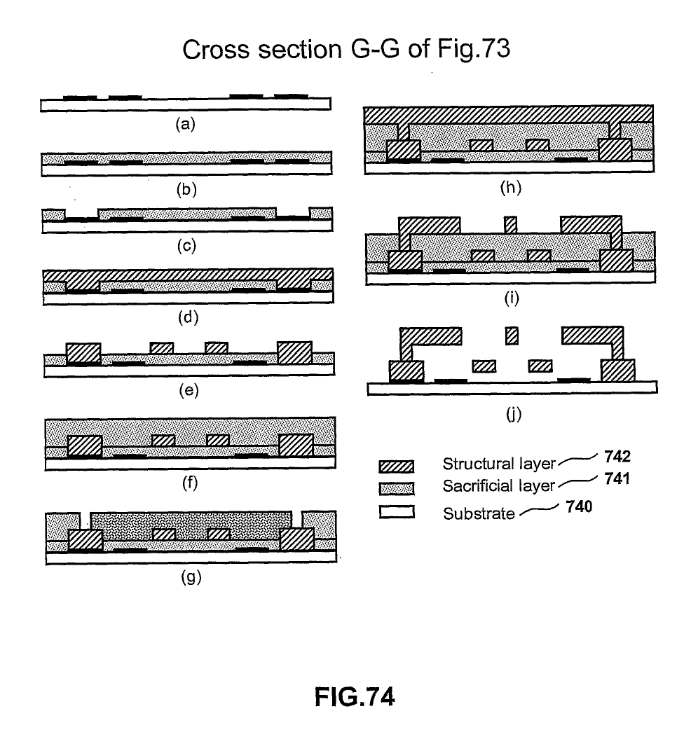

The grating actuator and various devices and systems employing the grating actuator and/or derived from the grating actuator can be fabricated with conventional micromachining processes that are generally known and described in standard publications. For example, surface-micromachining, bulk-micromachining or electroplating processes can all be used to fabricate actuators. For instance, the electroplating process or surface micromachining process as shown in FIG. 74 (cross-sectional view of the typical device of FIG. 73) may be used. This process is well known in MEMS (Micro Electro Mechanical Systems) field. In FIG. 73, the same numbers are assigned if the parts play the same roles as those in FIG. 1. In FIG. 73, patterned layer 732 is placed to provide wire (e.g. 13 in FIG. 2) for electrical connection or ground layer. FIG. 74 shows the typical fabrication process of the grating actuator of FIG. 73. The fabrication process of FIG. 74 uses three structural layers 742 and two sacrificial layers 741 on a substrate 740.

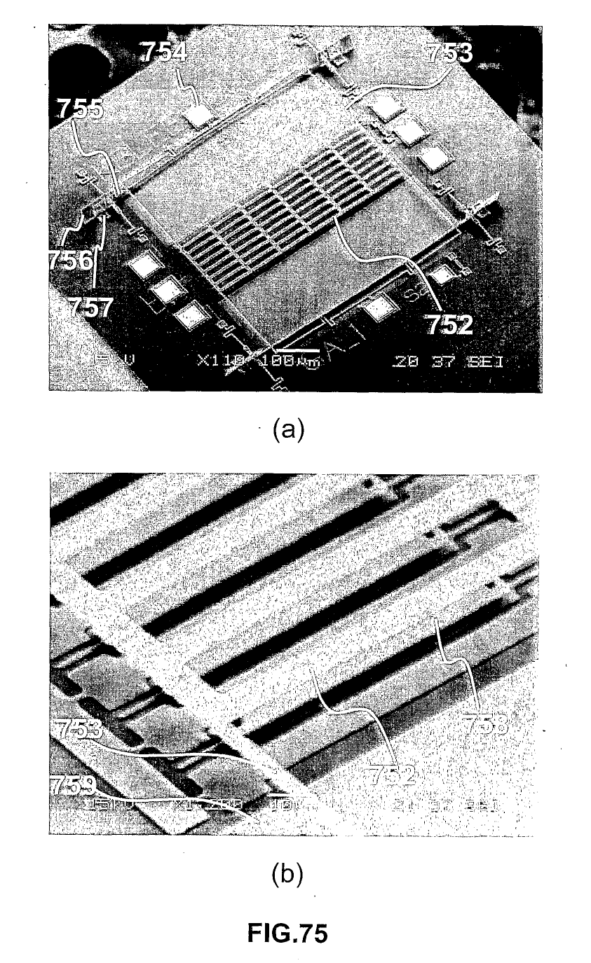

The present microactuator of Table 1 was fabricated by using a standard surface micromachining process (PolyMUMPS) employing three polysilicon layers (having thicknesses of 0.5 μm, 2.0 μm and 1.5 μm) and two sacrificial layers (having thicknesses of 2.0 μm and 1.75 μm). Since the sacrificial layers are rather thin, wide beams (as shown in FIG. 755 in FIG. 75a, for example) are used to elevate the fabricated movable grating structure. If higher sacrificial layers are required, other fabrication process may be used including, for example, different surface micromachining processes, bulk micromachining or LIGA (the German acronym “Lithographie, Galvanoformung, Abformung”), among others, may be used.

FIGS. 75a and 75b show Scanning Electron Microscope (SEM) photographs of the microactuator with the lifted grating and flexures. The fabricated actuator has dimensions 700 μm×700 μm. In FIG. 75a, the structural layer for the movable grating 752 are first fabricated and then lifted to the predetermined height (18 μm from the lower grating). The movable, stationary gratings and flexures are made of a 1.5 μm-thick polysilicon while the beams 755 (connected to the manipulation plate 756) under the flexures 753 are made of a 2 μm-thick polysilicon layer. 4 μm-wide slits are formed between the movable and stationary gratings 752 and 758 as shown in FIG. 75b. Because the thicknesses of the sacrificial silicon oxides (2 μm for sacrificial layer 1, and 0.75 μm for sacrificial layer 2) are much less than the required initial height of 18 μm (Table 1), the wide beams (755 in FIG. 75a) are used to achieve the initial height. The beams 755 are connected to the manipulation plate 756 and can be rotated about hinges 757 to lift the movable grating and flexures. Stretchable springs and hinges are designed to support the lifted beam 755 and flexures 753. A probe under a probe station (not shown in FIG. 75) is used to lift the movable grating 752 and flexure 753. When a manipulation plate 756 connected to a beam 755 is lifted by using the probe under a probe station, the manipulation plate 756 is rotated about the hinge 757, so that the beam 755 is lifted to support the flexures 753. The movable grating 752, connected to the flexure 753, is then lifted to its initial height. From FIG. 75b, the suspended movable grating 752 can be defined that is spaced by 18 μm apart from the stationary grating 758. If a different fabrication process with higher sacrificial layer is used, the beams 755, hinge 757, and manipulation plate 756 may not be needed.

The foregoing describes exemplary embodiments, which, as will be understood by those skilled in the art, may be subject to many variations or modifications in design, construction or operation without departing from the scope of the present invention as claimed.

1.-71. (canceled)

72. An electrostatic microactuator comprising:
at least one first electrodes;
at least one second electrodes spaced by a first predetermined distance apart from the at least one first electrodes, the at least one second electrodes attached to at least one flexure; and
a voltage source in electrical contact with the at least one first electrodes and the at least one second electrodes capable of applying an opposite polarity voltage to the at least one first electrodes and the at least one second electrodes, causing thereby electrostatic forces between the at least one first electrodes and the at least one second electrodes,
wherein the at least one first electrodes and the at least one second electrodes maintain at least a second distance under electrostatic attraction, and
wherein the at least one second electrodes attached to the at least one flexure have a stiffness and configuration so as to jump from a first unstable position to a stable pull-in position when the applied voltage is increased and reaches a pull-in voltage, and to jump from a second unstable position to a stable pull-out position when the applied voltage is decreased and reaches a pull-out voltage.

73. The electrostatic microactuator as recited in claim 72, wherein the at least one second electrodes are configured to be meshed with the at least one first electrodes when the applied voltage is increased above the pull-in voltage, so that at least one slit is formed between the at least one first and second electrodes.

74. The electrostatic microactuator as recited in claim 73, wherein a thickness of the at least one first and second electrodes is equal to or less than a width of the at least one slit.

75. The electrostatic microactuator as recited in claim 74, wherein the first predetermined distance between the at least one first and second electrodes is equal to or larger than the width of the at least one slit.

76. The electrostatic microactuator as recited in claim 73, wherein the at least one slit includes at least one selected from the group consisting of: triangular slits, square slits, rectangular slits, circular slits, ellipse slits, and polygon slits.

77. The electrostatic microactuator as recited in claim 72, wherein the at least one first electrodes have a configuration of a grating and the at least one second electrodes have the configuration of a grating.

78. The electrostatic microactuator as recited in claim 72, wherein the at least one first and second electrodes are comb shaped structures.

79. The electrostatic microactuator as recited in claim 72, wherein the at least one second electrodes and the at least one flexure are integrally formed.

80. The electrostatic microactuator as recited in claim 72, wherein the at least one second electrodes moves in at least one of a translation and a rotation.

81. The electrostatic microactuator as recited in claim 72, wherein the at least one first electrodes and the at least one second electrodes has a shape with an initial deformation and the shape is changed to a different shape when the voltage is applied the first and second electrodes.

82. The electrostatic microactuator as recited in claim 72, wherein the at least one first electrodes further comprises at least one flexible elements, so that the at least one first electrodes and the at least one second electrodes move towards each other when the voltage is applied.

83. The electrostatic microactuator as recited in claim 72, further comprising:
at least one third electrodes spaced by a third predetermined distance apart from the at least one second electrodes and positioned on an opposite side of the at least one first electrodes,
a second voltage source in electrical contact with the at least one second electrodes and the at least one third electrodes capable of applying a second opposite polarity voltage to the at least one second electrodes and the at least one third electrodes, causing thereby additional electrostatic forces between the at least on second electrodes and the at least one third electrodes.

84. A method of achieving large movements in an electrostatic structure having at least one stationary electrode; at least one movable electrode spaced at a predetermined distance from the at least one first stationary electrode attached to at least one flexure; and a voltage source in electrical contact with the at least one stationary electrode and the at least one movable electrode capable of applying an opposite polarity voltage to the at least one stationary electrode and the at least one movable electrode, causing thereby electrostatic forces between the at least one stationary electrode and the at least one moveable electrode, wherein the at least one movable electrode and the at least one stationary electrode maintains at least a second distance under electrostatic attraction, and wherein the at least one movable electrode attached to the at least one flexure have a stiffness and configuration so as to jump from a first unstable position to a stable pull-in position when the applied voltage is increased and reaches a pull-in voltage, and to jump from a second unstable position to a stable pull-out position when the applied voltage is decreased and reaches a pull-out voltage, comprising the steps of:
applying a time-varying voltage between the at least one stationary electrode and the at least one movable electrode wherein a maximum of the time-varying voltage is approximately equal to or greater than the pull-in voltage.

85. The method as recited in claim 84, wherein the time varying voltage is applied at a frequency approximately equal to a resonant frequency of the electrostatic microactuator.

86. An electrostatic microactuator comprising:
at least one first electrodes; and
at least one second electrodes spaced by a first predetermined distance apart from the at least one first electrodes, the at least one second electrodes attached to at least one flexure, the at least one second electrodes meshed with the at least one first electrodes,
wherein the at least one second electrodes and the at least one first electrodes are configured to maintain at least a second distance from each other under an electrostatic repulsion when electrical charges are accumulated on the at least one first electrodes and the at least one second electrodes, and
wherein the at least one second electrodes is displaced away from the at least one first electrodes under the electrostatic repulsion.

87. The electrostatic microactuator as recited in claim 86, wherein the at least one first electrodes and the at least one second electrodes are exposed to at least one of a charged particle, electrons, ion beam, plasma, X-ray, electromagnetic wave, light, electric field, and radioactive material so as to generate the accumulated charge on the at least one first electrodes and the at least one second electrodes.

88. The electrostatic microactuator as recited in claim 86, wherein the accumulated charge is discharged from at least one of the at least one first electrodes and the at least one second electrodes when the accumulated charge of the at least one first electrodes or the at least one second electrodes reaches a predetermined critical value of charge, thereby causing a reduction of the electrostatic repulsion, wherein the at least one second electrodes jumps from a critical position corresponding to the predetermined critical value of charge to a stable position.

89. The electrostatic microactuator of claim 86, wherein the at least one first electrodes and the at least one second electrodes are comb-shaped structures.

90. The electrostatic microactuator as recited in claim 86, wherein the at least one slit includes at least one selected from the group consisting of: triangular slits, square slits, rectangular slits, circular slits, ellipse slits, and polygon slits.

91. The electrostatic microactuator as recited in claim 86, wherein the at least one second electrodes moves in at least one of a translation and a rotation.
